(19) United States
(12) Patent Application Publication
(10) Pub. No.: US 2006/0072053 A1
(43) Pub. Date: Apr. 6, 2006

(54) Electroluminescent materials and devices

(76) Inventors: Poopathy Kathirgamanathan, North Harrow (GB); Richard Price, London (GB); Subramaniam Ganeshamurugan, London (GB); Paramaswara Gnanamoly, London (GB); Muttullingham Kumaraverl, Greenford (GB); Arumugam Partheepan, Mitcham (GB); Selvadurai Selvaranjan, Sutton (GB); Juan Antipan-Lara, London (GB); Sivagnanasundram Surendrakumar, Edgware (GB)

Correspondence Address: David Silverstein;Andover-IP-Law, Suite 300, 44 Park Street,, Andover, MA, 01810, US

(21) Appl. No.: 10/540,809

(22) PCT Filed: Dec. 19, 2003
(86) PCT No.: PCT/GB03/05573

§ 371 Date: Jul. 27, 2005

(30) Foreign Application Priority Data
Dec. 24, 2002 (GB) 0230072.1

(51) Int. Cl. G02F 1/00; C09K 11/06; G02F 1/1335

(52) U.S. Cl. 349/69; 252/301.16

(57) ABSTRACT

An electroluminescent compound is a organometallic complex in which the metal is titanium, zirconium, hafnium, vanadium, niobium or tantulum.

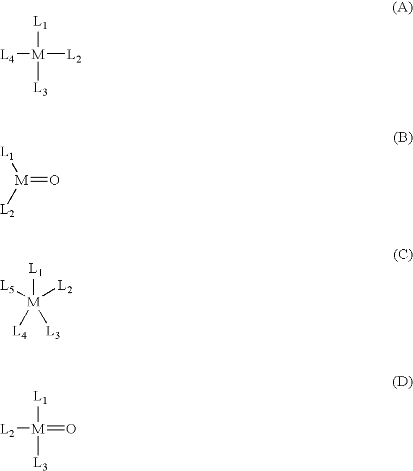

The present invention relates to electroluminescent materials and to electroluminescent devices.

Materials which emit light when an electric current is passed through them are well known and used in a wide range of display applications. Liquid crystal devices and devices which are based on inorganic semiconductor systems are widely used; however these suffer from the disadvantages of high energy consumption, high cost of manufacture, low quantum efficiency and the inability to make flat panel displays.

Organic polymers have been proposed as useful in electroluminescent devices, but it is not possible to obtain pure colours, they are expensive to make and have a relatively low efficiency.

Patent application WO98/58037 describes a range of lanthanide complexes which can be used in electroluminescent devices which have improved properties and give better results. Patent Applications PCT/GB98/01773, PCT/GB99/03619, PCT/GB99/04030, PCT/GB99/04024, PCT/GB99/04028, PCT/GB00/0268 describe electroluminescent complexes, structures and devices using rare earth chelates.

Another compound which has been proposed as an electroluminescent material for use in electroluminescent device is aluminium quinolate.

U.S. Pat. No. 3,995,299 (Partridge) discloses an electroluminescent device comprising in sequence, an anode, an organic hole injecting and transporting zone, a luminescent zone, an electron transporting zone and a cathode. The luminescent zone can be an organic polymer such as a polyvinyl carbazole doped with a fluorescent dye such as a perylene, an acridine, etc.

U.S. Pat. No. 4,769,292 (Kodak) discloses an electroluminescent device comprising in sequence, an anode, an organic hole injecting and transporting zone, a luminescent zone, and a cathode. The EL device is characterized in that the luminescent zone is formed by a thin film of less than 1 μm in thickness comprised of an organic host material and a fluorescent material capable of emitting light. The luminescent zone exemplified in the specification contains aluminium quinolate, and other metal quinolates with a valency of 1 to 3 are also referred to and claimed.

We have now surprisingly found that the use of organo metal complexes of metals with a valency of greater than 3, e.g. of 4, 5 or higher, give improved performance; preferably the organo metallic complex is a metal quinolate.

According to the invention there is provided electroluminescent compounds of formula M(L)ₙ and MO(L)ₙ₋₂ where M is a metal in a valency state n of greater than 3 and L is an organic ligand, the ligands L can be the same or different, e.g. M(L₁) (L₂) (L₃) (L₄) . . . or MO(L₁) (L₂). . . .

The invention also provides an electroluminescent device comprising sequentially an anode, a layer of an electroluminescent material comprising a compounds of formula M(L)ₙ and MO(L)ₙ₋₂ where M is a metal in a valency state n of greater than 3 and L is an organic ligand; the ligands L can be the same or different, e.g. M(L₁) (L₂) (L₃) (L₄) . . . or MO(L₁) (L₂). . . . and a cathode.

Preferably the metal M is a transition metal such as titanium, zirconium or hafnium in the four valency state or vanadium, niobium or tantulum in the five valency state.

Preferably the electroluminescent compound is doped with a minor amount of a fluorescent material as a dopant, preferably in an amount of 5 to 15% of the doped mixture.

As discussed in U.S. Pat. No. 4,769,292, the contents of which are included by reference, the presence of the fluoresecent material permits a choice from among a wide latitude of wavelengths of light emission.

By blending with the organo metallic complex, a minor amount of a fluorescent material capable of emitting light in response to hole-electron recombination, the hue light emitted from the luminescent zone can be modified. In theory, if an organo metallic complex and a fluorescent material could be found for blending which have exactly the same affinity for hole-electron recombination, each material should emit light upon injection of holes and electrons in the luminescent zone. The perceived hue of light emission would be the visual integration of both emissions.

Since imposing such a balance of the organo metallic complex and fluorescent materials is highly limiting, it is preferred to choose the fluorescent material so that it provides the favoured sites for light emission. When only a small proportion of fluorescent material providing favoured sites for light emission is present, peak intensity wavelength emissions typical of the organo metallic complex can be entirely eliminated in favour of a new peak intensity wavelength emission attributable to the fluorescent material. While the minimum proportion of fluorescent material sufficient to achieve this effect varies by the specific choice of organo metallic complex and fluorescent materials, in no instance is it necessary to employ more than about 10 mole percent fluorescent material, based on moles of organo metallic complex and seldom is it necessary to employ more than 1 mole percent of the fluorescent material. On the other hand, for any organo metallic complex capable of emitting light in the absence of fluorescent material, limiting the fluorescent material present to extremely small amounts, typically less than about 10⁻³ mole percent, based on organo metallic complex, can result in retaining emission at wavelengths characteristic of the organo metallic complex. Thus, by choosing the proportion of a fluorescent material capable of providing favoured sites for light emission, either a full or partial shifting of emission wavelengths can be realized. This allows the spectral emissions of the EL devices of this invention to be selected and balanced to suit the application to be served.

Choosing fluorescent materials capable of providing favoured sites for light emission, necessarily involves relating the properties of the fluorescent material to those of the organo metallic complex. The organo metallic complex can be viewed as a collector for injected holes and electrons with the fluorescent material providing the molecular sites for light emission. One important relationship for choosing a fluorescent material capable of modifying the hue of light emission when present in a organo metallic complex is a comparison of the reduction potentials of the two materials. The fluorescent materials demonstrated to shift the wavelength of light emission have exhibited a less negative reduction potential than that of the organo metallic complex. Reduction potentials, measured in electron volts, have been widely reported in the literature along with varied techniques for their measurement Since it is a comparison of reduction potentials rather than their absolute values which is desired, it is apparent that any accepted technique for reduction potential measurement can be employed, provided both the fluorescent and organo metallic complex reduction potentials are similarly measured. A preferred oxidation and reduction potential measurement techniques is reported by R. J. Cox, Photographic Sensitivity, Academic Press, 1973, Chapter 15.

A second important relationship for choosing a fluorescent material capable of modifying the hue of light emission when present in a organo metallic complex is a comparison of the bandgap potentials of the two materials. The fluorescent materials demonstrated to shift the wavelength of light emission have exhibited a lower bandgap potential than that of the organo metallic complex. The bandgap potential of a molecule is taken as the potential difference in electron volts (eV) separating its ground state and first singlet state. Bandgap potentials and techniques for their measurement have been widely reported in the literature. The bandgap potentials herein reported are those measured in electron volts (eV) at an absorption wavelength which is bathochromic to the absorption peak and of a magnitude one tenth that of the magnitude of the absorption peak. Since it is a comparison of bandgap potentials rather than their absolute values which is desired, it is apparent that any accepted technique for bandgap measurement can be employed, provided both the fluorescent and organo metallic complex band gaps are similarly measured. One illustrative measurement technique is disclosed by F. Gutman and L. E. Lyons, Organic Semiconductors, Wiley, 1967, Chapter 5.

Where an organo metallic complex is chosen, which is itself capable of emitting light in the absence of the fluorescent material, it has been observed that suppression of light emission at the wavelengths of emission characteristics of the organo metallic complex alone and enhancement of emission at wavelengths characteristic of the fluorescent material occurs when spectral coupling of the organo metallic complex and fluorescent material is achieved. By spectral coupling it is meant that an overlap exists between the wavelengths of emission characteristic of the organo metallic complex alone and the wavelengths of light absorption of the fluorescent material in the absence of the organo metallic complex. Optimal spectral coupling occurs when the m±25 nm the maximum absorption of the fluorescent material alone. In practice advantageous spectral coupling can occur with peak emission and absorption wavelengths differing by up to 100 nm or more, depending on the width of the peaks and their hypsochromic and bathochromic slopes. Where less than optimum spectral coupling between the organo metallic complex and fluorescent materials is contemplated, a bathochromic as compared to a hypsochromic displacement of the fluorescent material produces more efficient results.

Although the foregoing discussion has been undertaken by reference to organo metallic complexes which are known to themselves emit light in response to hole and electron injection, in fact light emission by the organo metallic complex itself can entirely cease where light emission by the fluorescent material is favoured by any one or combination of the various relationships noted above. It is appreciated that shifting the role of light emission to the fluorescent material allows a still broader range of choices of organo metallic complexes. For example, one fundamental requirement of a material chosen to emit light is that it must exhibit a low extinction coefficient for light of the wavelength it emits to avoid internal absorption. The present invention permits use of organo metallic complexes which are capable of sustaining the injection of holes and electrons, but are themselves incapable of efficiently emitting light.

Useful fluorescent materials are those capable of being blended with the organo metallic complex and fabricated into thin films satisfying the thickness ranges described above forming the luminescent zones of the EL devices of this invention. While crystalline organo metallic complexes do not lend themselves to thin film formation, the limited amounts of fluorescent materials present in the organo metallic complex materials permits the use of fluorescent materials which are alone incapable of thin film formation. Preferred fluorescent materials are those which form a common phase with the organo metallic complex material. Fluorescent dyes constitute a preferred class of fluorescent materials, since dyes lend themselves to molecular level distribution in the organo metallic complex. Although any convenient technique for dispersing the fluorescent dyes in the organo metallic complexes can be undertaken, preferred fluorescent dyes are those which can be vacuum vapor deposited along with the organo metallic complex materials. Assuming other criteria, noted above, are satisfied, fluorescent laser dyes are recognized to be particularly useful fluorescent materials for use in the organic EL devices of this invention. Dopants which can be used include diphenylacridine, coumarins, perylene and their derivatives.

Useful fluorescent dopants are disclosed in U.S. Pat. No. 4,769,292 the contents of which are included by reference.

The preferred dopants are coumarins such as those of formula 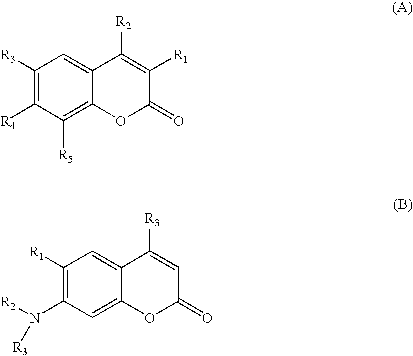
where R₁ is chosen from the group consisting of hydrogen, carboxy, alkanoyl, alkoxycarbonyl, cyano, aryl, and a heterocylic aromatic group, R₂ is chosen from the group consisting of hydrogen, alkyl, haloalkyl, carboxy, alkanoyl, and alkoxycarbonyl, R₃ is chosen from the group consisting of hydrogen and alkyl, R₄ is an amino group, and R₅ is hydrogen, or R₁ or R₂ together form a fused carbocyclic ring, and/or the amino group forming R⁴ completes with at least one of R⁴ and R⁶ a fused ring.

The alkyl moieties in each instance contain from 1 to 5 carbon atoms, preferably 1 to 3 carbon atoms. The aryl moieties are preferably phenyl groups. The fused carbocyclic rings are preferably five, six or seven membered rings. The heterocyclic aromatic groups contain 5 or 6 membered heterocyclic rings containing carbon atoms and one or two heteroatoms chosen from the group consisting of oxygen, sulfur, and nitrogen. The amino group can be a primary, secondary, or tertiary amino group. When the amino nitrogen completes a fused ring with an adjacent substituent, the ring is preferably a five or six membered ring. For example, R₁ can take the form of a pyran ring when the nitrogen atom forms a single ring with one adjacent substituent (R³ or R⁵) or a julolidine ring (including the fused benzo ring of the coumarin) when the nitrogen atom forms rings with both adjacent substituents R₃ and R₅.

The following are illustrative fluorescent coumarin dyes known to be useful as laser dyes: FD-1 7-Diethylamino-4-methylcoumarin, FD-2 4,6-Dimethyl-7-ethylaminocoumarin, FD-3 4-Methylumbelliferone, FD-4 3-(2′-Benzothiazolyl)-7-diethylaminocoumarin, FD-5 3-(2′-Benzimidazolyl)-7-N,N-diethylaminocoumarin, FD-6 7-Amino-3-phenylcoumarin, FD-7 3-(2′-N-Methylbenzimidazolyl)-7-N,Ndiethylaminocoumarin, FD-8 7-Diethylamino-4-trifluoromethylcoumarin, FD-9 2,3,5,6-1H,4H-Tetrahydro-8-methylquinolazino[9,9a1-gh]coumarin, FD-10 Cyclopenta[c]julolindino[9,10-3]-11H-pyran-11-one, FD-11 7-Amino-4-methylcoumarin, FD-12 7-Dimethylaminocyclopenta[c]coumarin, FD-13 7-Amino-4-trifluoromethylcoumarin, FD-14 7-Dimethylamino-4-trifluoromethylcoumarin, FD-15 1,2,4,5,3H,6H,10H-Tetrahydro-8-trifluoromethyl[1]benzopyrano[9,9a,1-gh]quinolizin-10-one, FD-16 4-Methyl-7-(sulfomethylamino)coumarin sodium salt, FD-17 7-Ethylamino-6-methyl-4-trifluoromethylcoumarin, FD-18 7-Dimethylamino-4-methylcoumarin, FD-19 1,2,4,5,3H,6H,10H-Tetrahydrocarbethoxy[1]benzopyrano[9,9a,1-gh]quinolizino-10-one, FD-20 9-Acetyl-1,2,4,5,3H,6H, 10H-tetrahydro[1]benzopyrano[9,9a,1-gh]quinolizino-10-one, FD-21 9-Cyano-1,2,4,5,3H,6H,10H-tetrahydro[1]benzopyrano[9,9a,1-gh]quinolizino-10-one, FD22 9-(t-Butoxycarbonyl)-1,2,4,5,3H,6H, 10H-tetrahyro[1]benzopyrano[9,9a,1-gh]quinolizino-10-one, FD-23 4-Methylpiperidino[3,2-g]coumarin, FD-24 4-Trifluoromethylpiperidino[3,2-g]coumarin, F25 9-Carboxy-1 2,4,5,3H,6H,10H-tetrahydro[1]benzopyrano[9,9a, 1-gh]quinolizino-10-one, FD-26 N-Ethyl-4-tifluoromethylpiperidino[3,2-g].

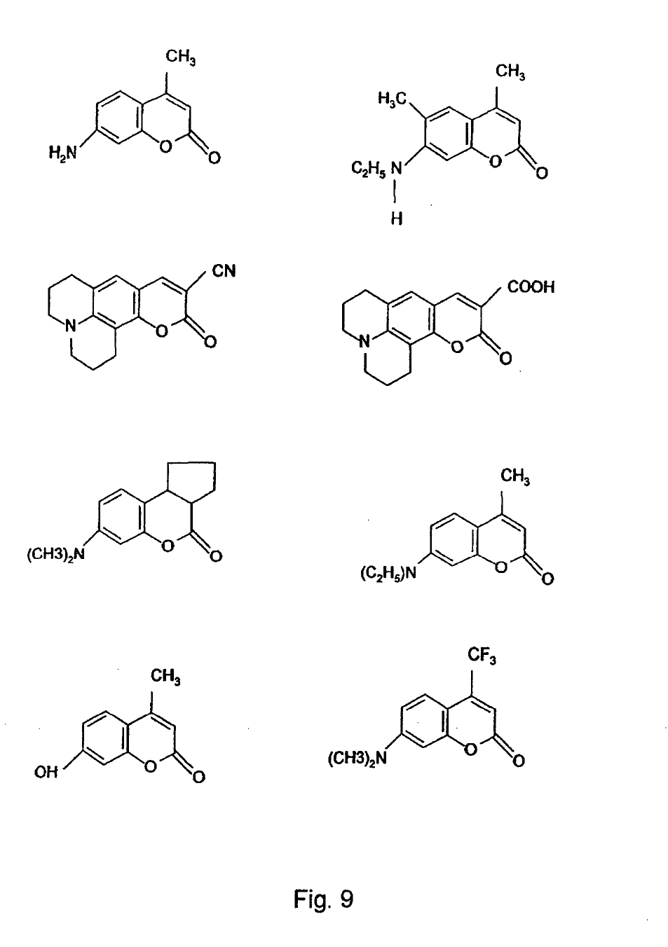

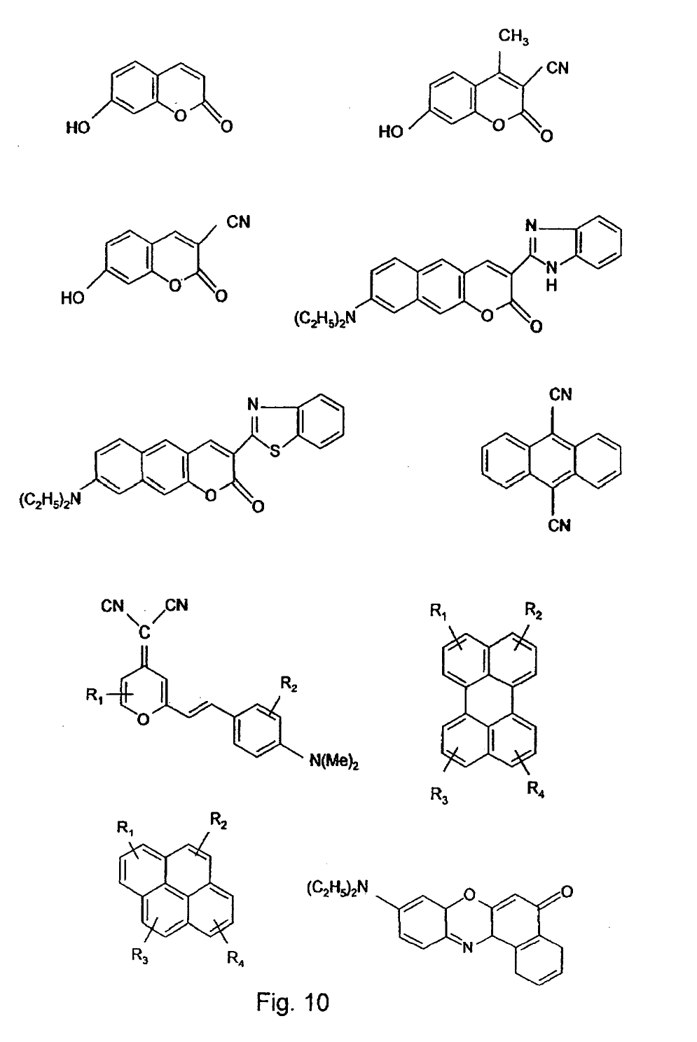

Other examples of coumarins are given in FIG. 9 of the drawings.

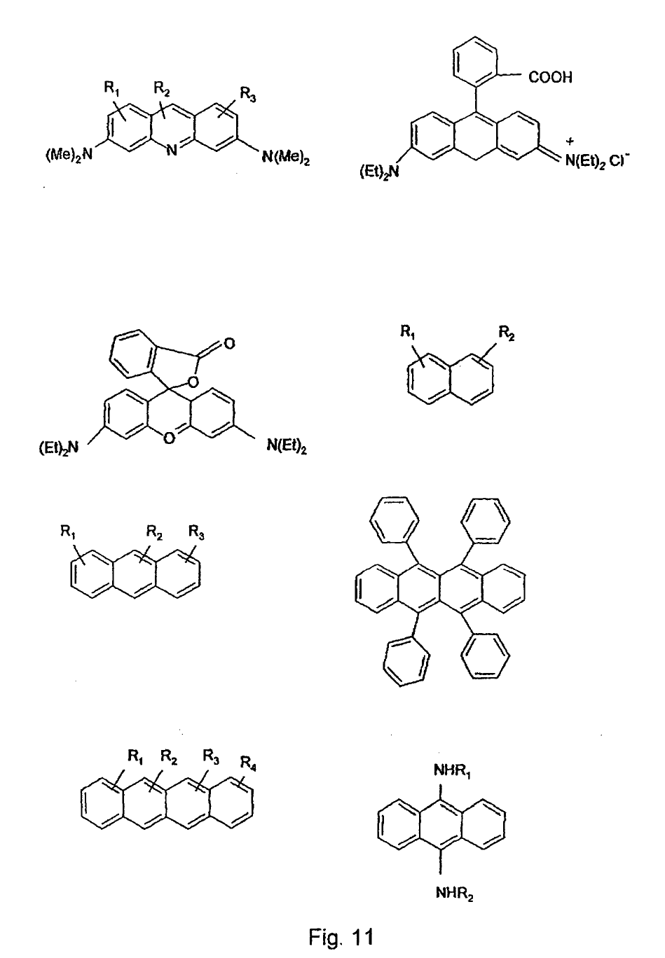

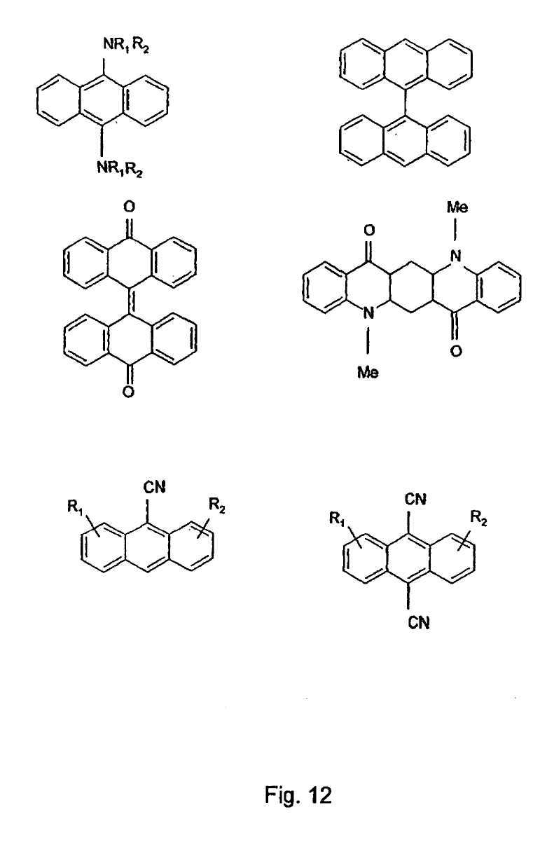

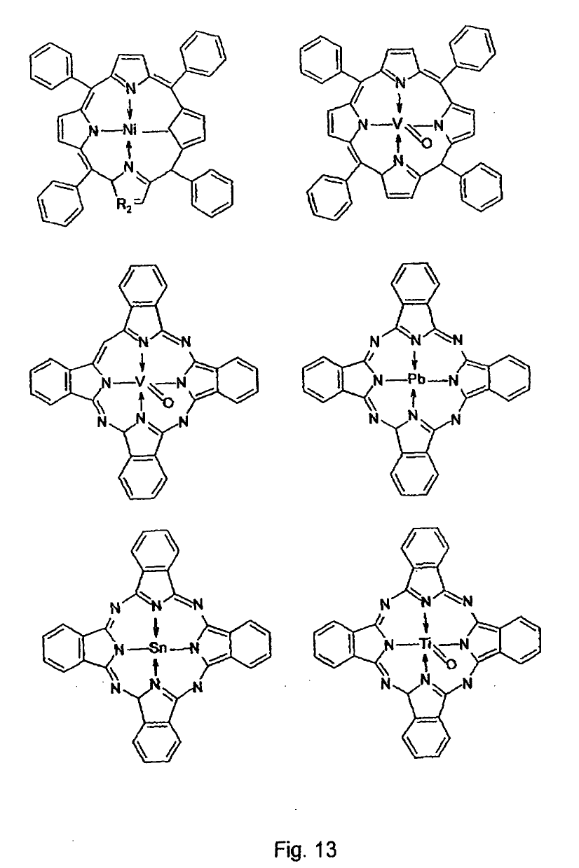

Other dopants include salts of bis benzene sulphonic acid such as 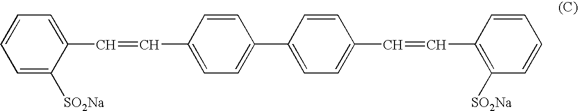
and perylene and perylene derivatives and dopants of the formulae of FIGS. 11 to 13 of the drawings where R₁, R₂, R₃ and R₄ are R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluorly methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups
—C—CH₂═CH₂—R
where R is as above.

Other dopants are dyes such as the fluorescent 4-dicyanomethylene-4H-pyrans and 4 dicyanomethylene-4H-thiopyrans, e.g. the fluorescent dicyanomethylenepyran and thiopyran dyes.

Useful fluorescent dyes can also be selected from among known polymethine dyes, which include the cyanines, merocyanines, complex cyanines and merocyanines (i.e. tri-, tetra- and poly-nuclear cyanines and merocyanines), oxonols, hemioxonols, styryls, merostyryls, and streptocyanines.

The cyanine dyes include, joined by a methine linkage, two basic heterocyclic nuclei, such as azolium or azinium nuclei, for example, those derived from pyridinium, quinolinium, isoquinolinium, oxazolium, thiazolium, selenazolium, indazolium, pyrazolium, pyrrolium, indolium, 3H-indolium, imidazolium, oxadiazolium, thiadioxazolium, benzoxazolium, benzothiazolium, benzoselenazolium, benzotellurazolium, benzimidazolium, 3H- or 1H-benzoindolium, naphthoxazolium, naphthothiazolium, naphthoselenazolium, naphthoteflurazolium, carbazolium, pyrrolopyridinium, phenanthrothiazolium, and acenaphthothiazolium quaternary salts.

Other useful classes of fluorescent dyes are 4-oxo-4H-benz-[d,e]anthracenes and pyrylium, thiapyrylium, selenapyrylium, and telluropyrylium dyes.

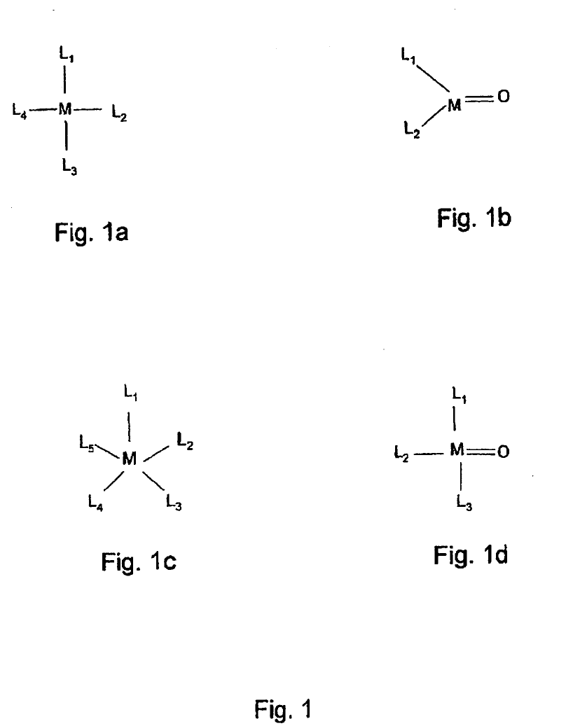

The formulae of examples of the organo metallic complexes are shown in FIG. 1a and FIG. 1b of the accompanying drawings where M is titanium, zirconium or hafnium in the four valency state and (L₁), (L₂), (L₃) and (L₄) can be the same of different and can form fused cyclic, heterocyclic, aromatic or substituted aromatic rings or FIG. 1c and 1d where M is vanadium, niobium or tantulum in the five valency state and (L₁), (L₂), (L₃) (L₄) and (L₅) can be the same or different and can form fused cyclic, heterocyclic, aromatic or substituted aromatic rings.

Other preferred ligands L are quinolate, porphoryin, porphines, pyrazalones, such as 5,10,15,20-tetra(4-pyridyl) 21H,23H-porphine 5,10,15,20-tetra(p-tolyl) 21H,23H-porphine and meso-tetraphenyl porphine and β diketones such as dibenzoyl methane and ligands of formula 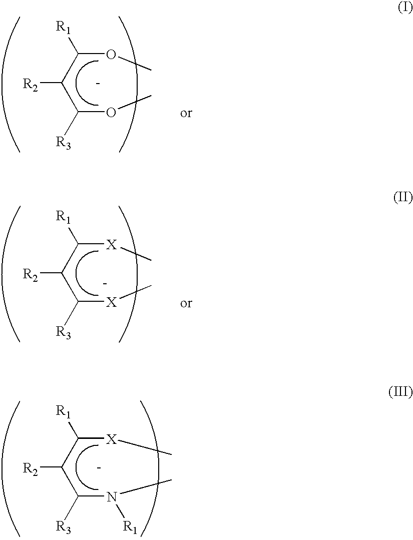
where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, atlthracene, naphthyl and fluorene groups alkyl groups such as t-butyl, heterocyclic groups such as carbazole.

In dibenzoyl methane in (I) R₁ and R₃ are phenyl groups and R₂ is hydrogen.

Other ligands L can be 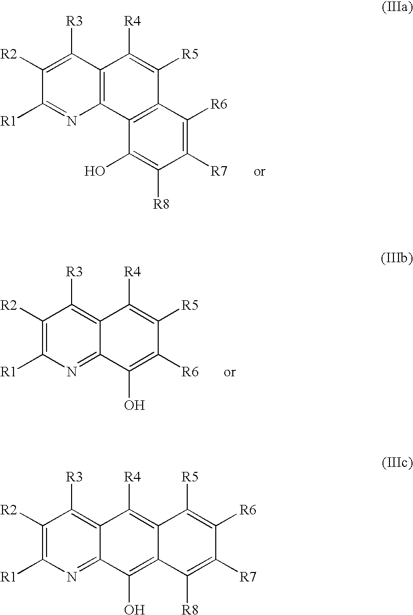
where the groups R can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene.

Some of the different groups L may also be the same or different charged groups such as carboxylate groups so that the group L₁ can be as defined above and the groups L₂, L₃ . . . can be charged groups such as 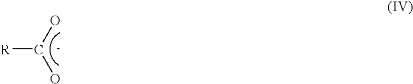
where R is R₁ as defined above or the groups L₁, L₂ can be as defined above and L₃ . . . etc. are other charged groups.

R₁, R₂ and R₃ can also be 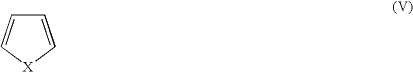
where X is O, S, Se or NH.

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltrifluoroacetone, 1-naphthoyltrifluoroacetone, 2-naphthoyltrifluoroacetone, 2-phenathoyltrifluoroacetone, 3-phenanlthoyltrifluoroacetone, 9-anthroyltrifluoroacetonetrifluoroacetone, cinnamoyltrifluoroacetone, and 2-thenoyltrifluoroacetone.

The different groups L may be the same or different ligands of formulae 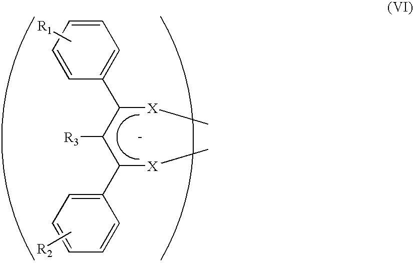
where X is O, S, or Se and R₁ R₂ and R₃ are as above.

The different groups L may be the same or different quinolate derivatives such as 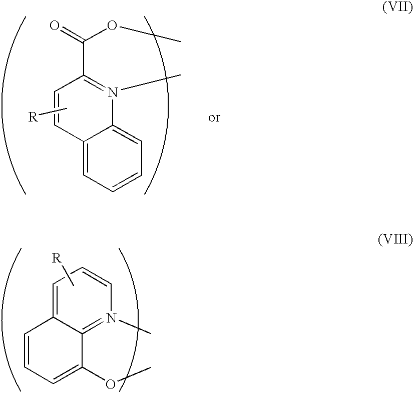
where R is hydrocarbyl, aliphatic, aromatic or heterocyclic carboxy, aryloxy, hydroxy or alkoxy, e.g. the 8 hydroxy quinolate derivatives or 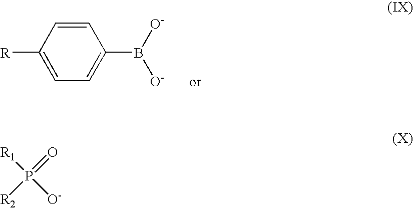
where R, R₁, and R₂ are as above or are H or F e.g. R₁ and R₂ are alkyl or alkoxy groups

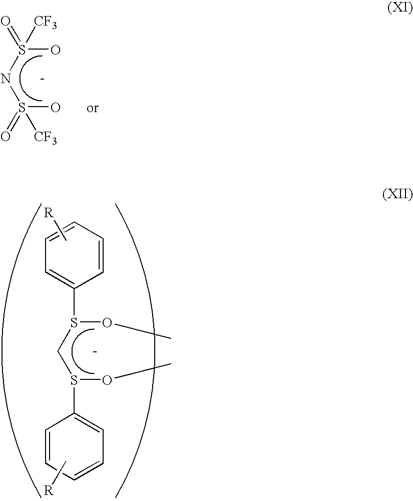

As stated above the different groups L may also be the same or different carboxylate groups e.g. 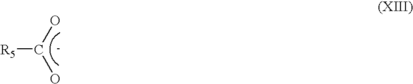
where R₅ is a substituted or unsubstituted aromatic, polycyclic or heterocyclic ring a polypyridyl group, R₅ ran also be a 2-ethyl hexyl group so Lₙ is 2-ethylhexanoate or R₅ can be a chair structure so that Lₙ is 2-acetyl cyclohexanoate or Lα can be 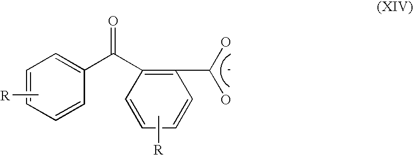
where R is as above e.g. alkyl, allenyl, amino or a fused ring such as a cyclic or polycyclic ring.

The different groups L may also be 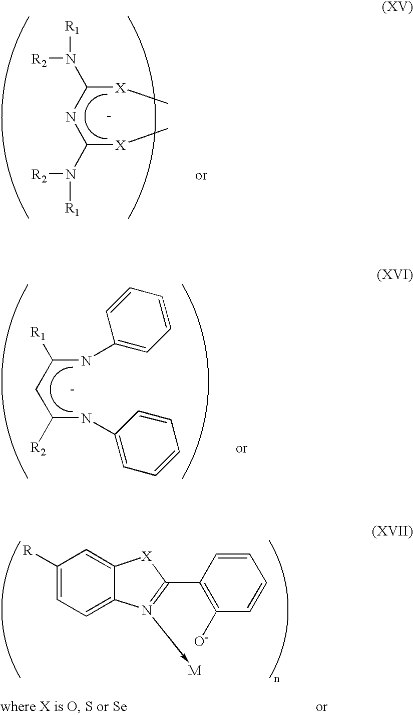 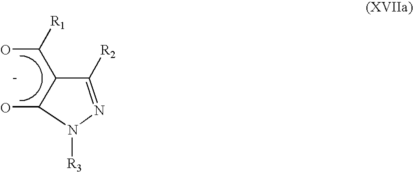
where R, R₁ and R₂ are as above.

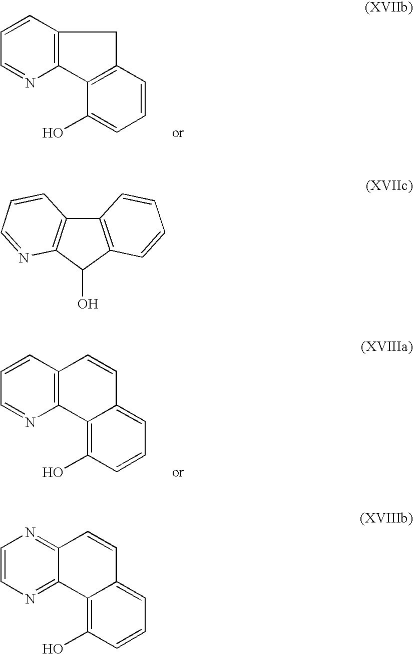

A preferred ligand is quinolate and preferred electroluminescent compounds are the metal salts of substituted or unsubstituted 8-hydroxy quinoline which are referred to herein as metal quinolates. Thus the preferred electroluminescent compounds are titanium, zirconium, hafnium, vanadium, niobium and tantalum quinolates.

These have the general formula 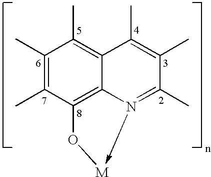
where m is the metal, n is the valency state of the metal and the where the substituents are the same or different in the 2, 3, 4, 5, 6 and 7 positions and are preferably selected from alkyl, alkoxy, aryl, aryloxy, sulphonic acids, esters, carboxylic acids, amino and amido groups or are aromatic, polycyclic or heterocyclic groups. The preferred quinolates are the 2-methyl and the 5-methyl quinolates.

Metal quinolates can be synthesised by the reaction of a metal compound such as a salt, ethoxide or alkyl 8-hydroxyquinoline in accordance with well known methods.

For electroluminescent materials the reaction preferably takes place in a nitrile solvent such as acetonitrile, phenyl nitrile, tolyl nitrile, etc.

The invention also provides an electroluminescent device which comprises (i) a first electrode, (ii) a layer of a electroluminescent compound as described above and (iii) a second electrode.

The first electrode can function as the anode and the second electrode can function as the cathode and preferably there is a layer of a hole transporting material between the anode and the layer of the electroluminescent compound.

The hole transporting material can be any of the hole transporting materials used in electroluminescent devices.

The hole transporting material can be an amine complex such as poly (vinylcarbazole), N,N′-diphenyl-N,N′-bis (3-methylphenyl)-1,1′-biphenyl-4,4′-diamine (TPD), an unsubstituted or substituted polymer of an amino substituted aromatic compound, a polyaniline, substituted polyanilines, polythiophenes, substituted polythiophenes, polysilanes etc. Examples of polyanilines are polymers of 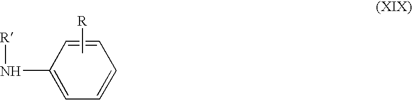
where R is in the ortho- or meta-position and is hydrogen, C1-18 alkyl C1-6 alkoxy, amino, chloro, bromo, hydroxy or the group 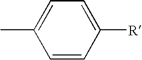
where R is alky or aryl and R′ is hydrogen, C1-6 alkyl or aryl with at least one other monomer of formula I above.

Or the hole transporting material can be a polyaniline; polyanilines which can be used in the present invention have the general formula 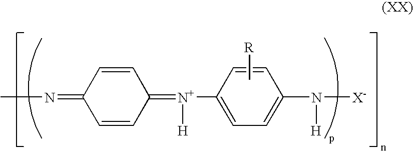
where p is from 1 to 10 and n is from 1 to 20, R is as defined above and X is an anion, preferably selected from Cl, Br, SO₄, BF₄, PF₆, H₂PO₃, H₂PO₄, arylsulphonate, aenedicarboxylate, polystyrenesulphonate, polyacrylate alkysulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate; an example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated, however we have surprisingly found that if the unsubstituted or substituted polymer of an amino substituted aromatic compound is deprotonated, then it can be easily evaporated, i.e. the polymer is evaporable.

Preferably evaporable deprotonated polymers of unsubstituted or substituted polymer of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F. Epstein, Faraday Discussions, Chem Soc. 88 P319 1989.

The conductivity of the polyaniline is dependant on the degree of protonation with the maximum conductivity being when the degree of protonation is between 40 and 60%, for example, about 50%.

Preferably the polymer is substantially fully deprotonated.

A polyaniline can be formed of octamer units. i.e. p is four. e.g.

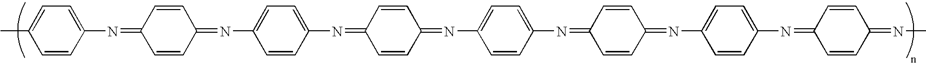

The polyanilines can have conductivities of the order of 1×10⁻¹ Siemen cm⁻¹ or higher.

The aromatic rings can be unsubstituted or substituted, e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an amino substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted, e.g. by a group R as defined above.

Other hole transporting materials are conjugated polymer and the conjugated polymers which can be used can be any of the conjugated polymers disclosed or referred to in U.S. Pat. No. 5,807,627, PCT/WO90/13148 and PCT/WO92/03490.

The preferred conjugated polymers are poly (phenylenevinylene-PPV and copolymers including PPV. Other preferred polymers are poly(2,5 dialkoxyphenylene vinylene) such as poly (2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, ploythiophenes and oligothiophenes.

In PPV the phenylene ring may optionally carry one or more substituents, e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as anthracene or naphthlyene ring and the number of vinylene groups in each polyphenylenevinylene moiety can be increased, e.g. up to 7 or higher.

The conjugated polymers can be made by the methods disclosed in U.S. Pat. No. 5,807,627, PCT/WO90/13148 and PCT/WO92/03490.

The thickness of the hole transporting layer is preferably 20 nm to 200 nm.

The polymers of an amino substituted aromatic compound such as polyanilines referred to above can also be used as buffer layers with or in conjunction with other hole transporting materials.

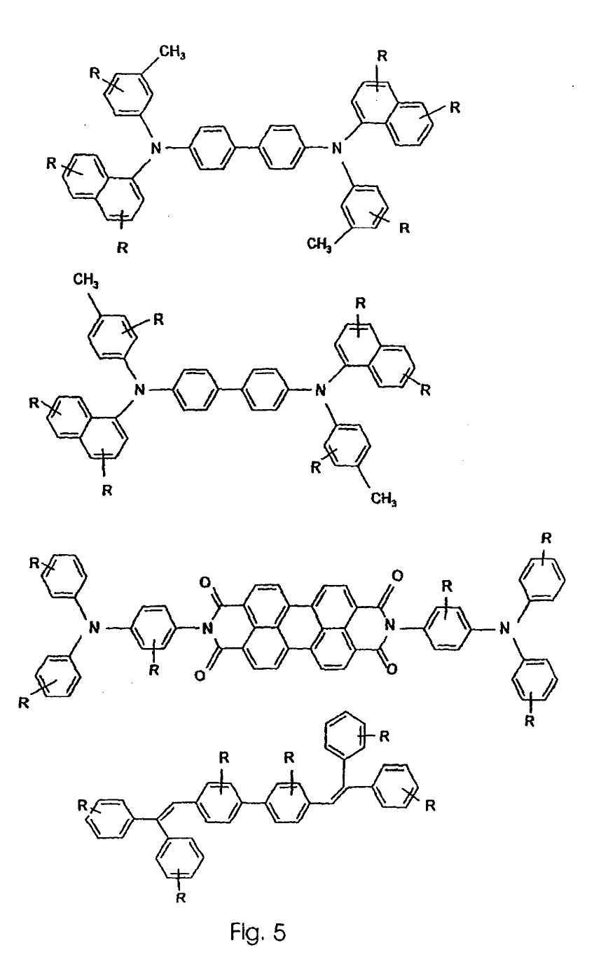

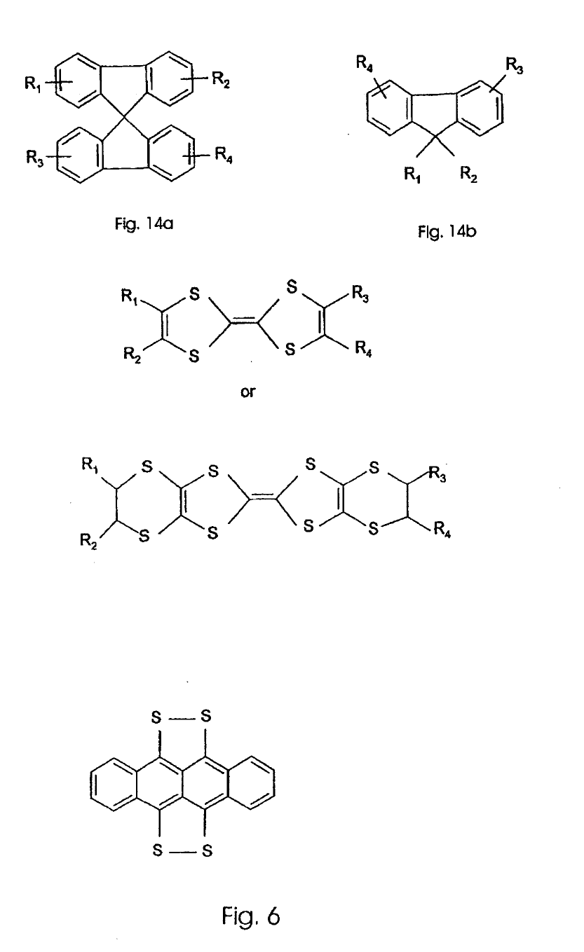

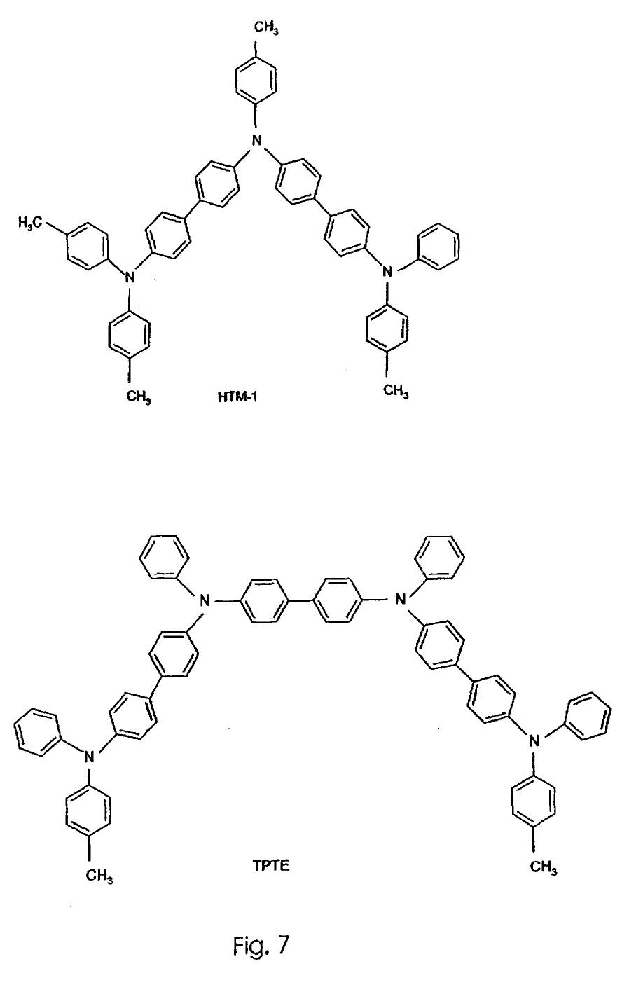

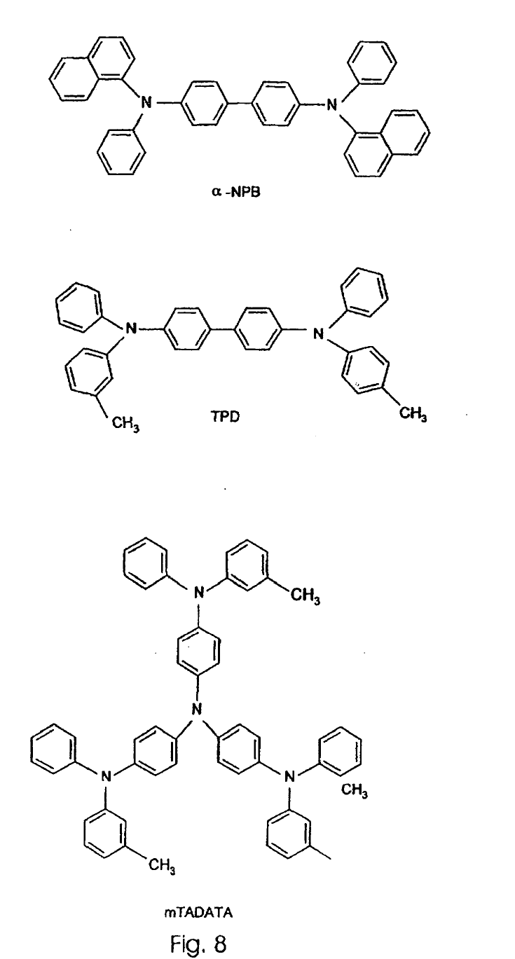

The structural formulae of some other hole transporting materials are shown in FIGS. 4, 5, 6, 7 and 8 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

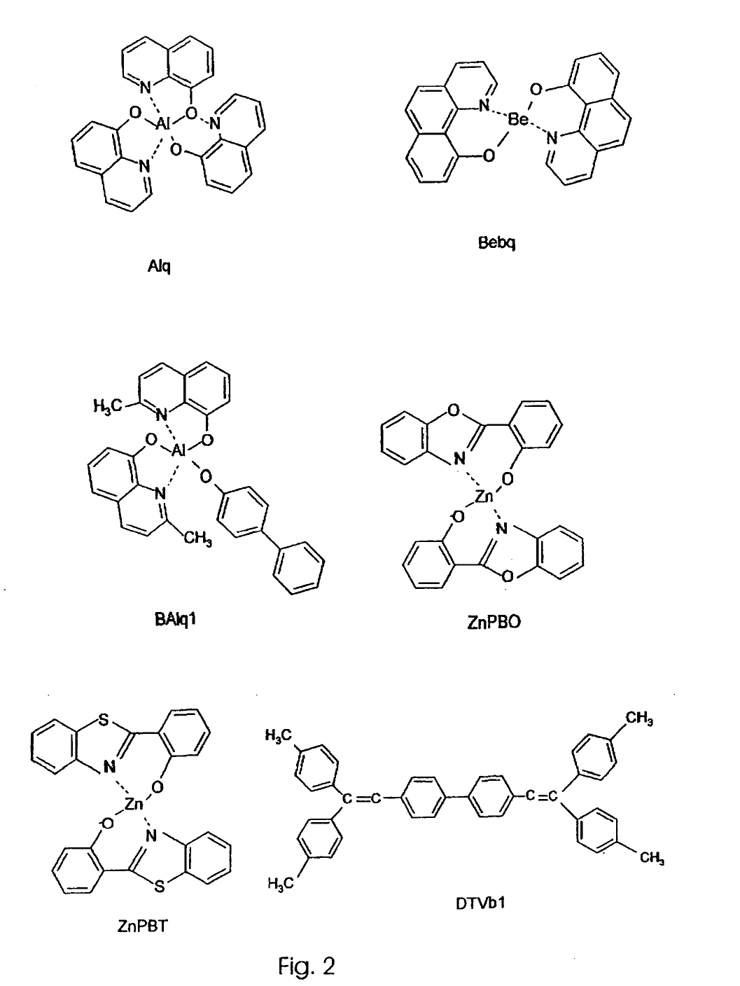

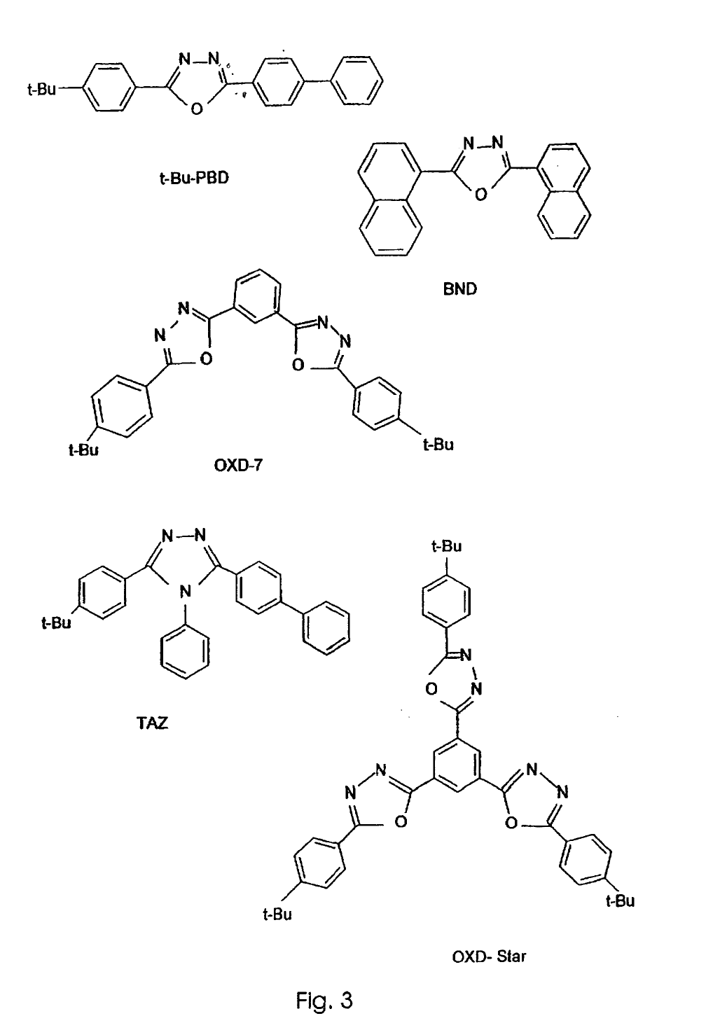

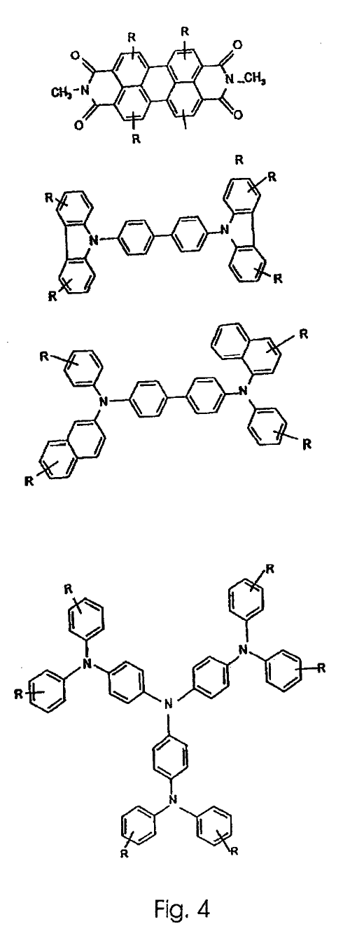

Optionally there is a layer of an electron injecting material between the anode and the electroluminescent material layer. The electron injecting material is a material which will transport electrons when an electric current is passed through electron injecting materials include a metal complex such as a metal quinolate, e.g. an aluminium quinolate, lithium quinolate, zirconium quinolate, a cyano anthracene such as 9,10 dicyano anthracene, cyano substituted aromatic compounds, tetracyanoquinidodimethane a polystyrene sulphonate or a compound with the structural formulae shown in FIG. 2 or 3 of the drawings in which the phenyl rings can be substituted with substituents R as defined above.

When the electroluminescent layer in an electroluminescent device comprises a doped zirconium quinolate, then a preferred electron injecting material is zirconium quinolate.

The fist electrode is preferably a transparent substrate such as a conducive glass or plastic material which acts as the anode; preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate.

The cathode is preferably a low work function metal, e.g. aluminium, calcium, lithium, silver/magnesium alloys, rare earth metal alloys etc; aluminium is a preferred metal. A metal fluoride such as an alkali metal, rare earth metal or their alloys can be used as the second electrode, for example by having a metal fluoride layer formed on a metal.

The improved performance of the organo metallic quinolates where the metal has a valency greater than 3 compared with the state of the art, aluminium quinolate is particularly shown in the efficiency of the electroluminescent compound although there is an improvement in a range of properties, e.g. lifetime, stability etc.

The invention is further described with reference to the Examples.

### EXAMPLE 1

A pre-etched ITO coated glass piece (10×10 cm²) was used. The device was fabricated by sequentially forming on the ITO, by vacuum evaporation using a Solciet Machine, ULVAC Ltd. Chigacki, Japan the active area of each pixel was 3 mm by 3 mm, the layers comprised:—

ITO (100 Ω/sqr. m)/CuPc (15 nm)/α-NPB (75 nm)/Zrq₄:DPQA (75:0.75 nm)/LiF (0.4 nm)/Al.

Where ITO is indium tin oxide coated glass Cu Pc is copper phthalocyanine, α-NPB is as defined in the specification, Zrq₄ is zirconium quinolate and DPQA is diphenylquinacridine.

The Zrq₄ is zirconium quinolate and the Zrq₄:DPQA layer was formed by concurrent vacuum deposition to form a zirconium quinolate layer doped with DPQA. The weight ratio of the Zrq₄ and DPQA is conveniently shown by a relative thickness measurement.

The coated electrodes were stored in a vacuum desiccator over a molecular sieve and phosphorous pentoxide until they were loaded into a vacuum coater (Edwards, 10⁻⁶ torr) and aluminium top contacts made. The devices were then kept in a vacuum desiccator until the electroluminescence studies were performed.

The ITO electrode was always connected to the positive terminal. The current vs. voltage studies were carried out on a computer controlled Keithly 2400 source meter.

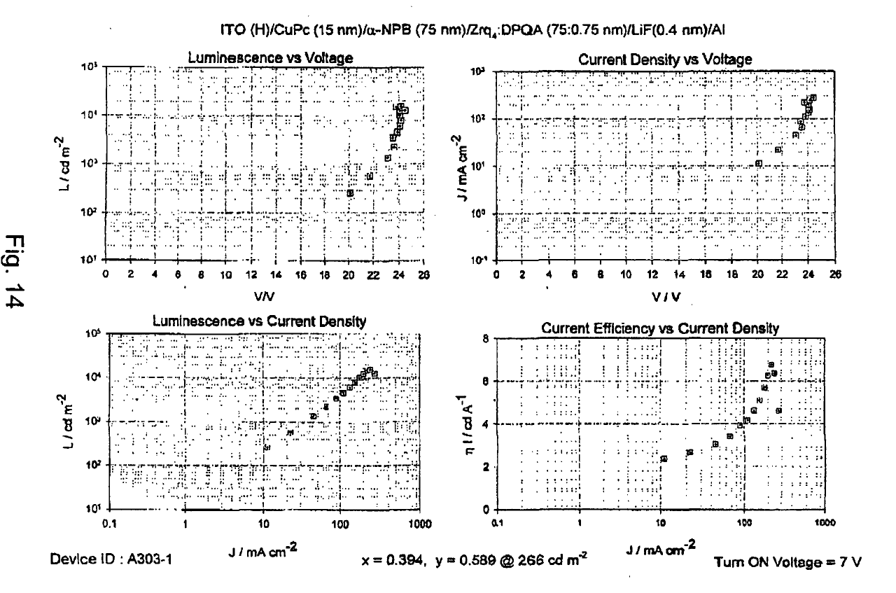

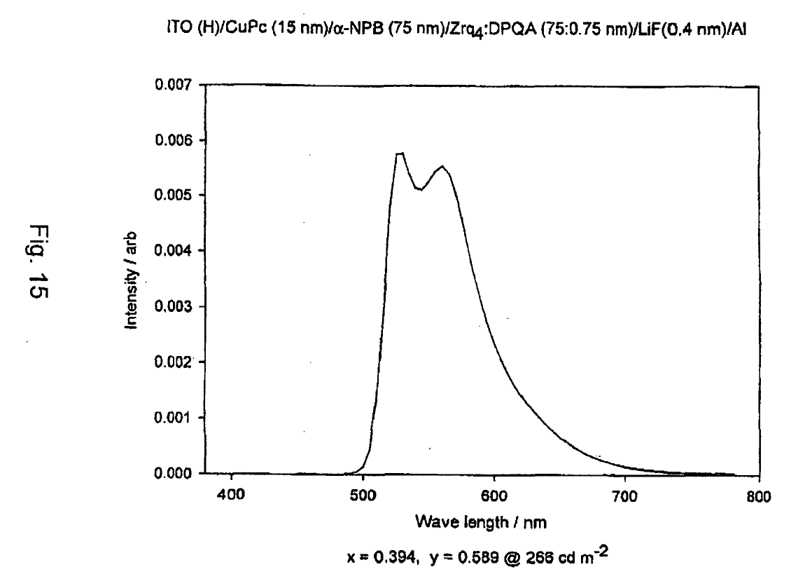

An electric current was applied across the device and the performance shown in FIG. 14; the electroluminescence spectrum is shown in FIG. 15.

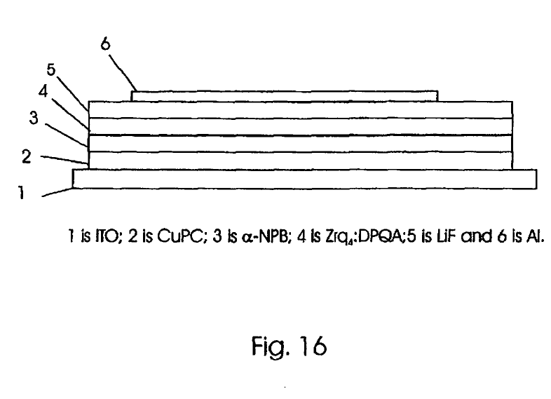

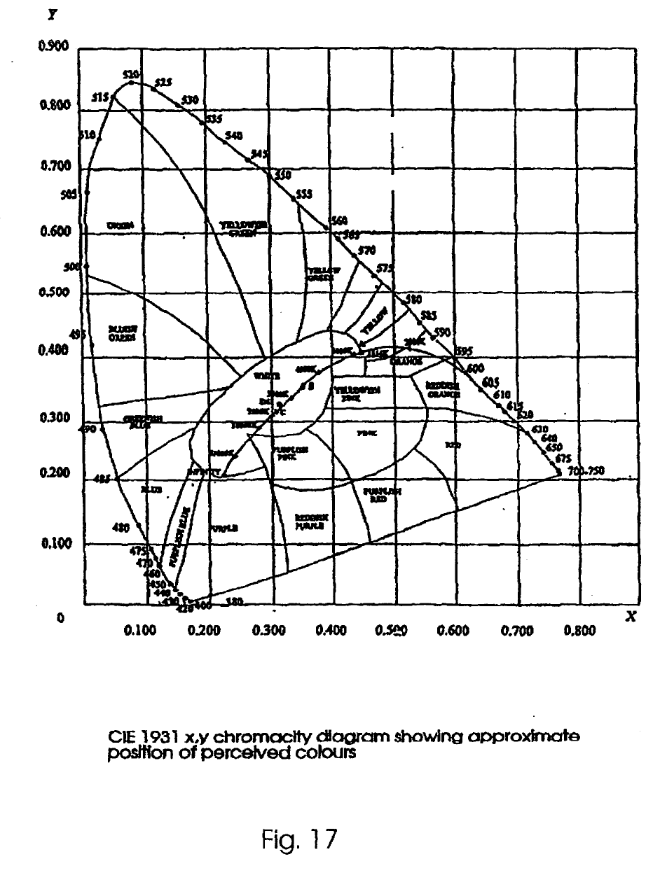

The device had the structure of FIG. 16 and the colours are as in the CIE colour chart of FIG. 17.

### EXAMPLE 2

A device was fabricated according to the method of Example 1 with the structure ITO/CuPc (25 nm)/α-NPB (75 nm)/Zrq₄:Nilered (75:0.38 nm)/LiF (0.4 nm)/Al, where nilered is

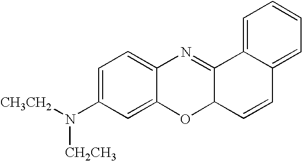

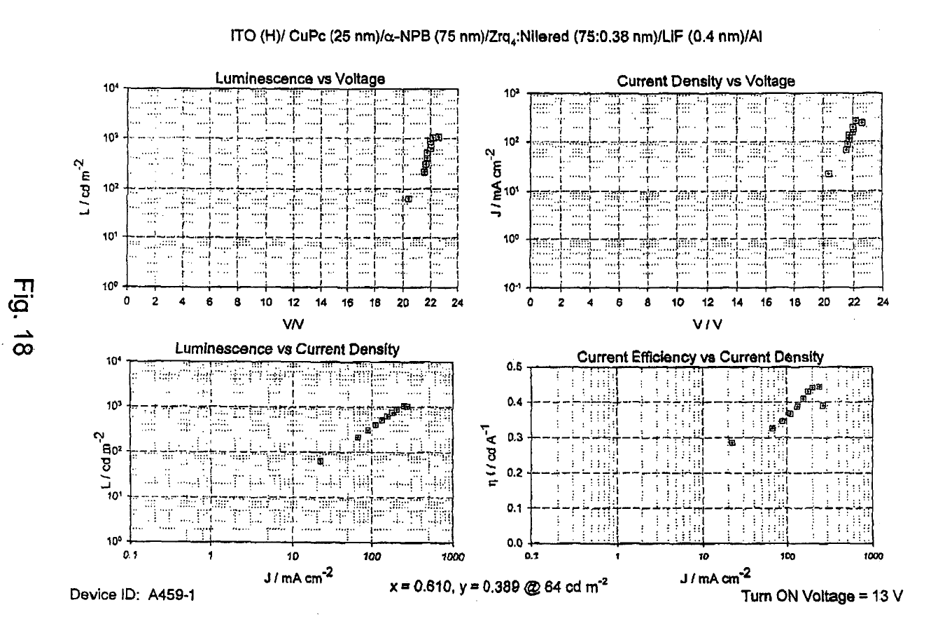

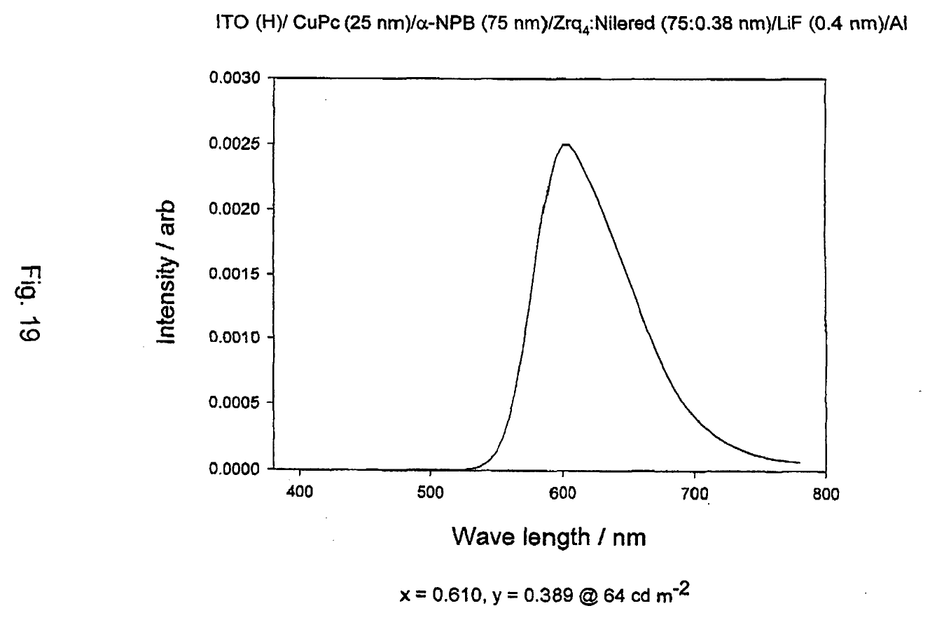

An electric current was applied across the device and the performance shown in FIG. 18; the electroluminescence spectrum is shown in FIG. 19.

### EXAMPLE 3

A device was fabricated according to the method of Example 1 with the structure ITO (100 Ω/sqr. m)/CuPc (25 nm)/α-NPB (75 nm)/Zrq₄:DPQA (60:0.4 nm)/Zrq₄ (10 nm)/LiF (0.4 nm)/Al.

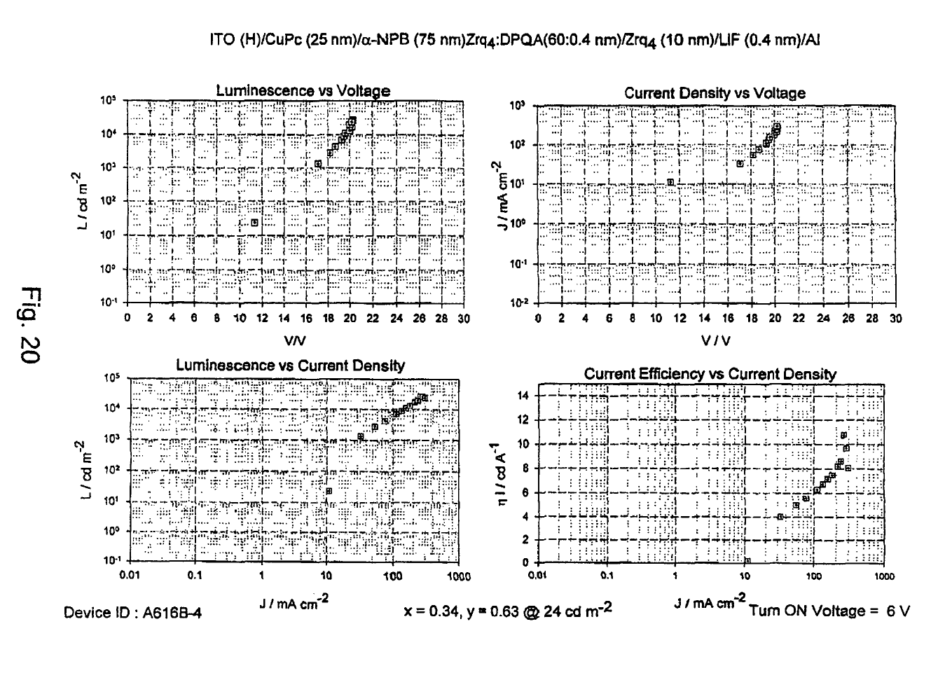

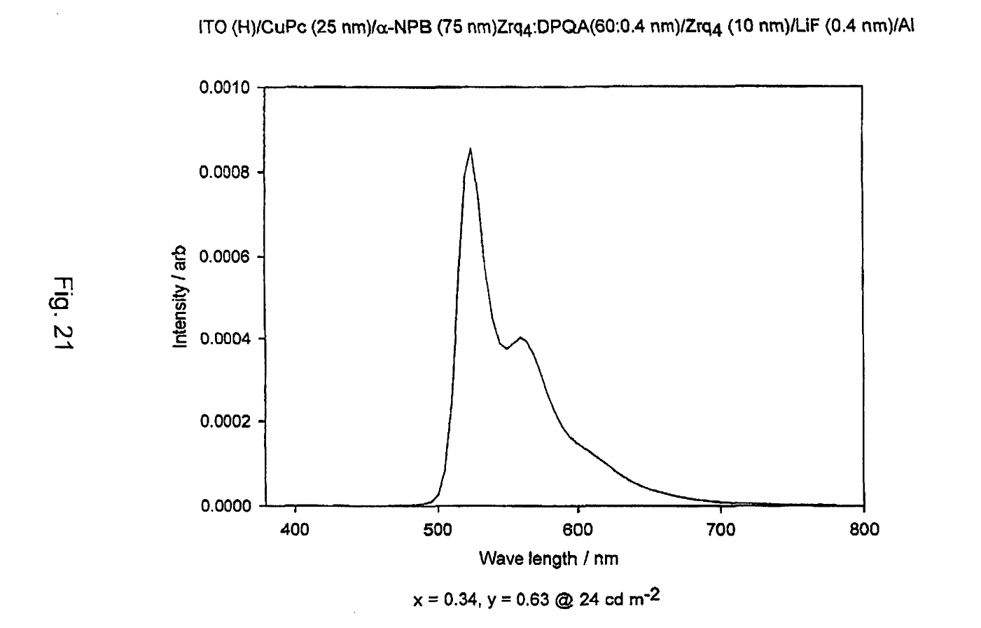

An electric current was applied across the device and the performance shown in FIG. 20; the electroluminescence spectrum is shown in FIG. 21.

### EXAMPLE 4

A device was fabricated according to the method of Example 1 with the structure ITO (100 Ω/sqr. m)/CuPc:TPTP (15:15 nm)/α-NPB (75 nm)/Zrq₄:DPQA (60:0.5 nm)/LiF (0.2 nm)/Al.

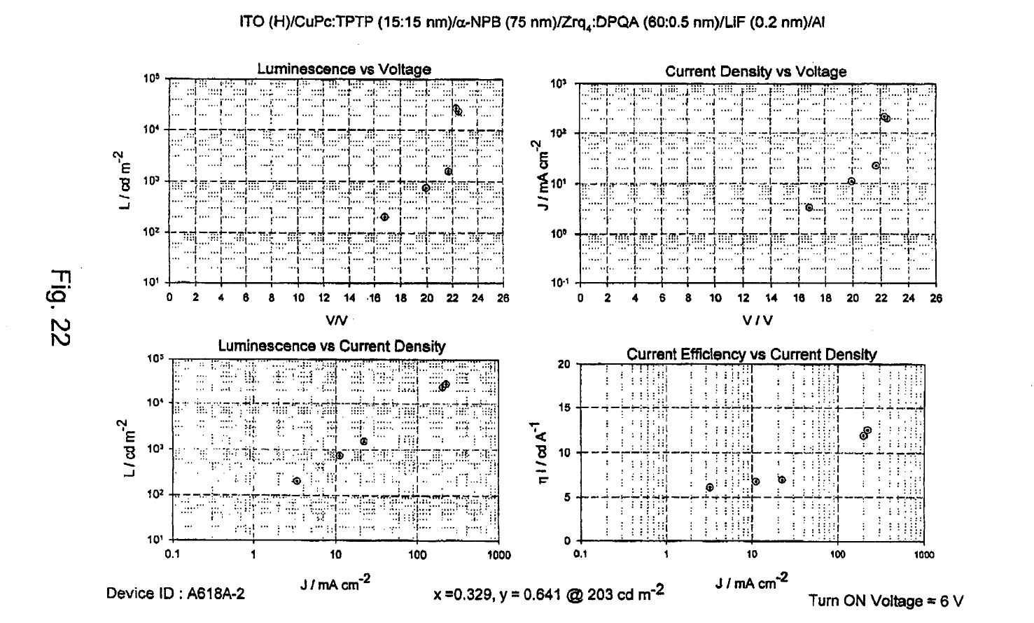

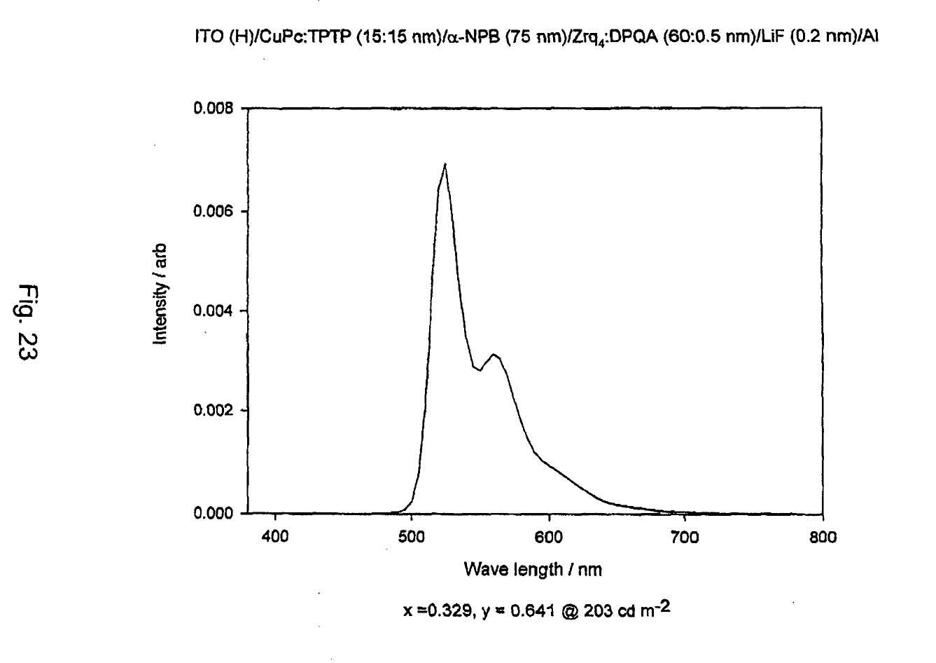

An electric current was applied across the device and the performance shown in FIG. 22; the electroluminescence spectrum is shown in FIG. 23.

### EXAMPLE 5

A device was fabricated according to the method of Example 1 with the structure ITO (100 Ω/sqr. m)/CuPc (25 nm)/α-NPB (75 nm)/Zrq₄:DPQA (60:0.4 nm)/Zrq₄/LiF (0.4 nm)/Al.

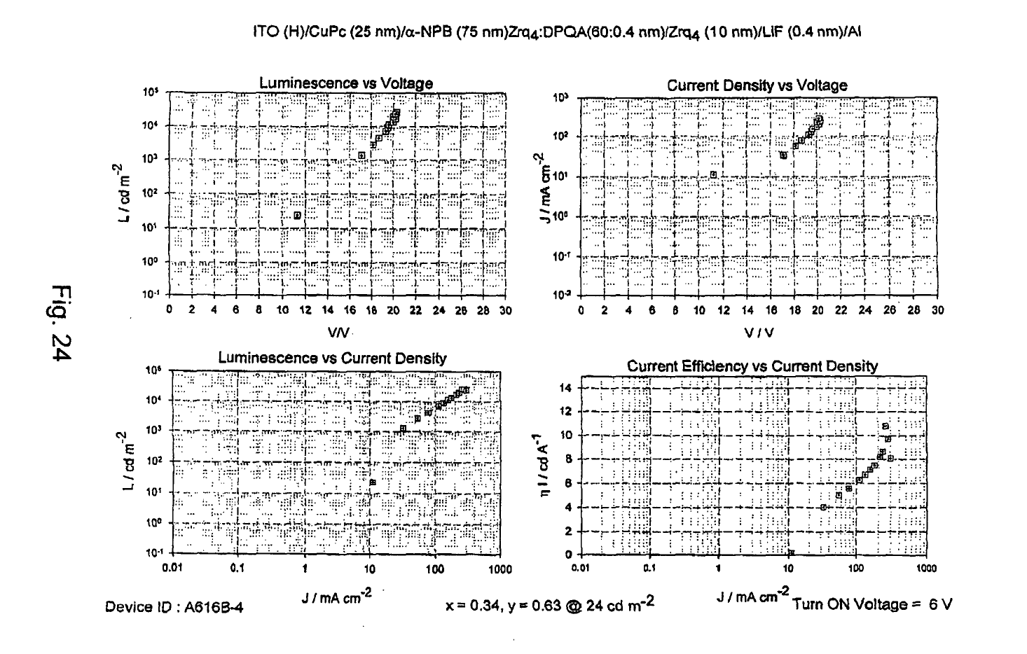

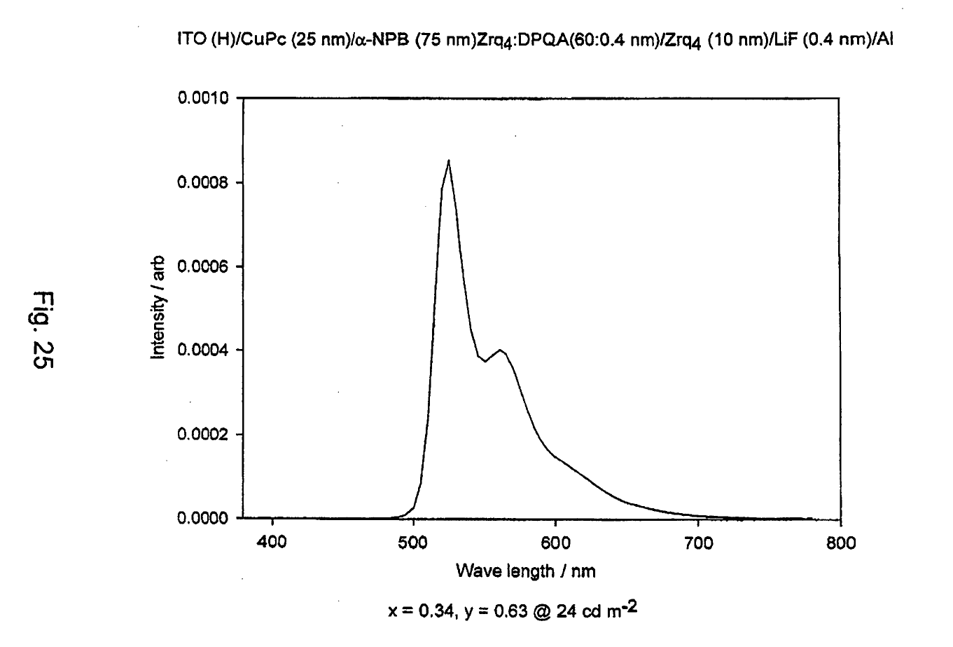

An electric current was applied across the device and the performance shown in FIG. 24; the electroluminescence spectrum is shown in FIG. 25.

### EXAMPLE 6

A device was fabricated according to the method of Example 1 with the structure ITO (100 Ω/sqr. m)/CuPc (25 nm)/α-NPB (60 nm)/Zrq₄:DCJT (35:0.5 nm) 1 Zrq₄(35 nm/LiF (0.5 nm)/Al.

Where DCJT is 4-(Dicyanomethylene)-2-methyl-6-(julolidin-4-yl-vinyl)-4H-pyran.

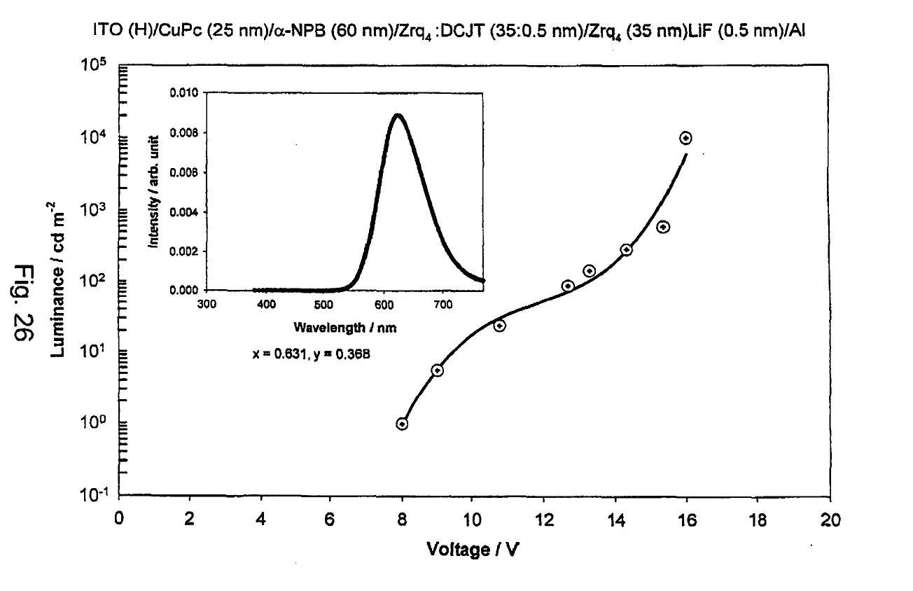

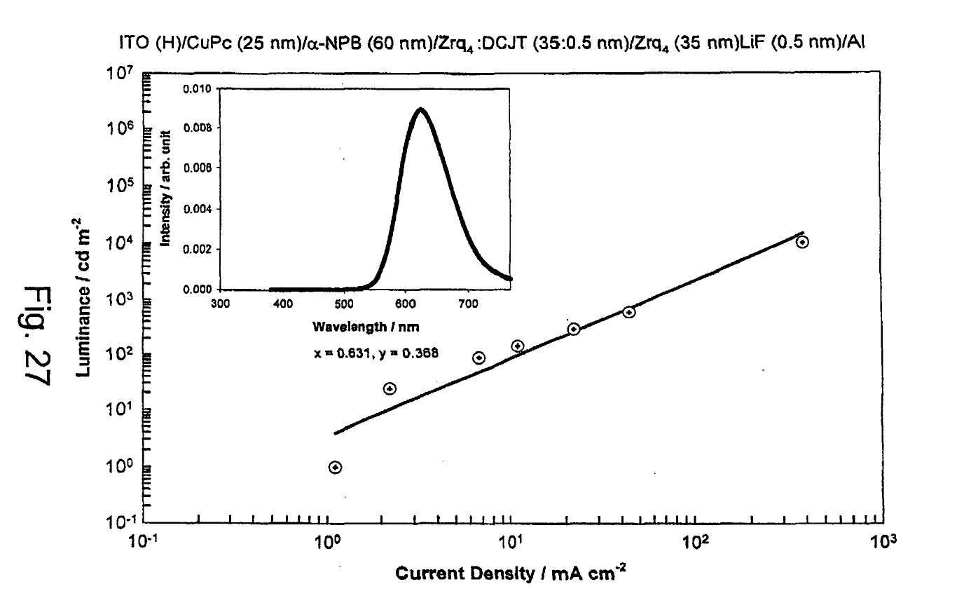

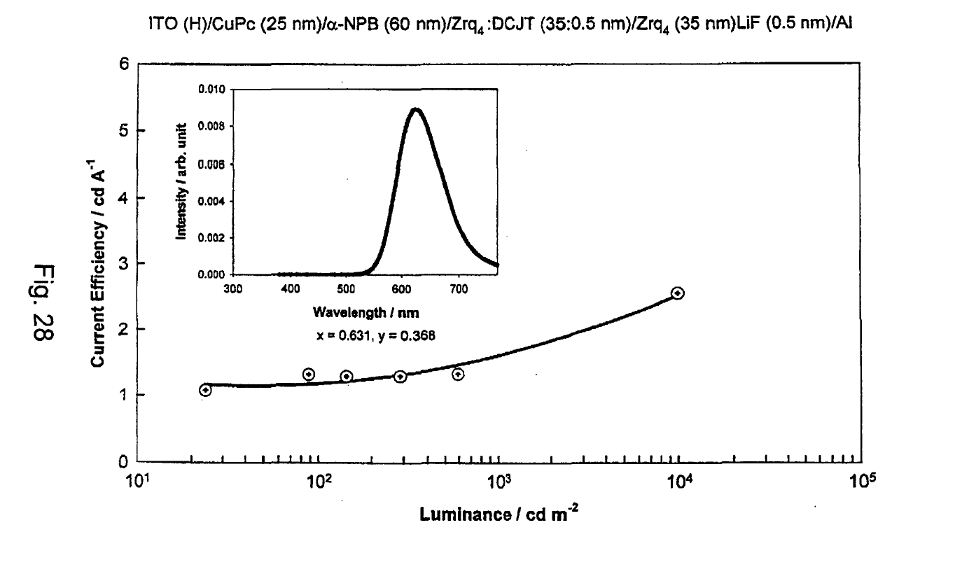

An electric current was applied across the device and the performance shown in FIGS. 26 to 28.

### EXAMPLE 7

A device was fabricated according to the method of Example 1 with the structure ITO (100 Ω/sqr. m)/CuPc (50 nm)/α-NPB (75 nm)/Zrq₄:DCM (60:0.5 nm)/Zrq₄(10 nm/KF (0.4 nm)/Al.

Where KF is potassium fluoride and where DCM is 4-(Dicyanomethylene)-2-methyl-6-(p-dimethylaminostyryl)-4H-pyran.

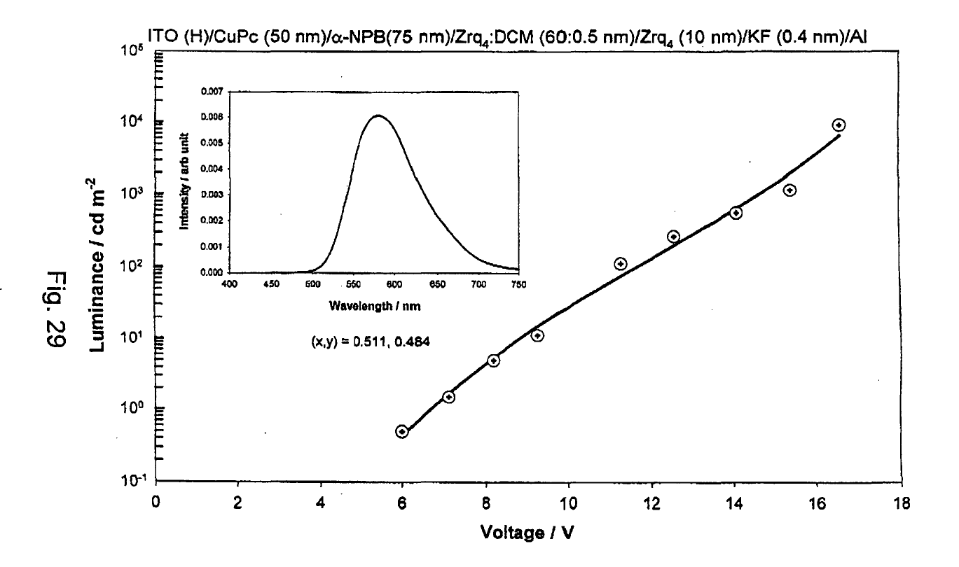

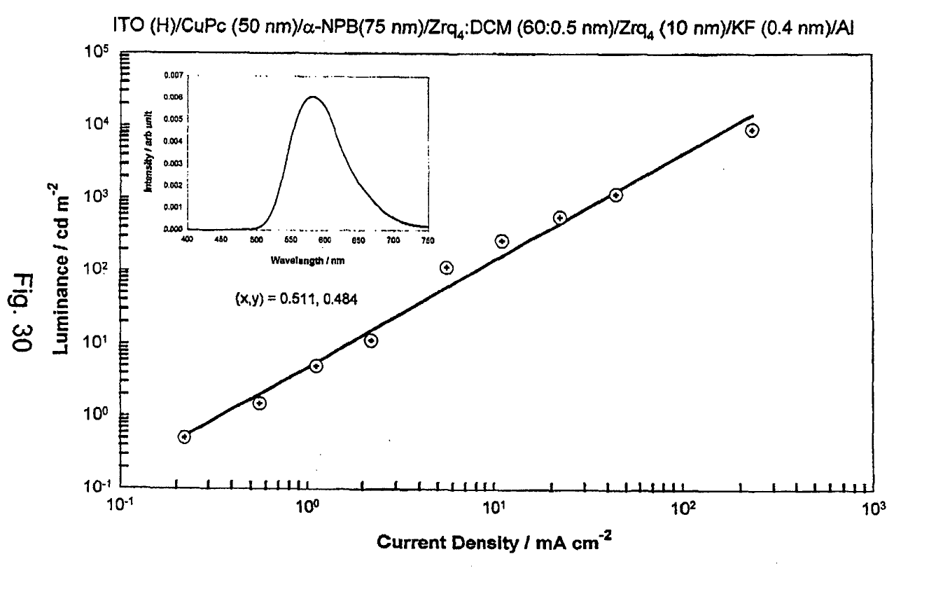

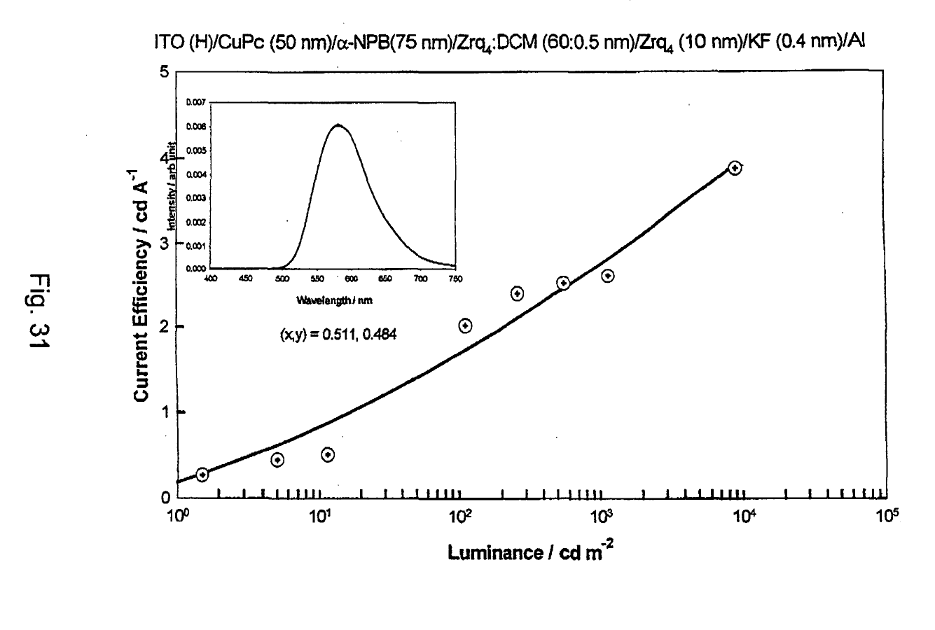

An electric current was applied across the device and the performance shown in FIGS. 29 to 31.

### EXAMPLE 8

A device was fabricated according to the method of Example 1 with the structure ITO (100 Ω/sqr. m)/CuPc (50 nm)/α-NPB (75 nm)/Zrq₄:DPQA (60:0.5 nm) 1 Zrq₄(35 nm (0.5 nm)/Al.

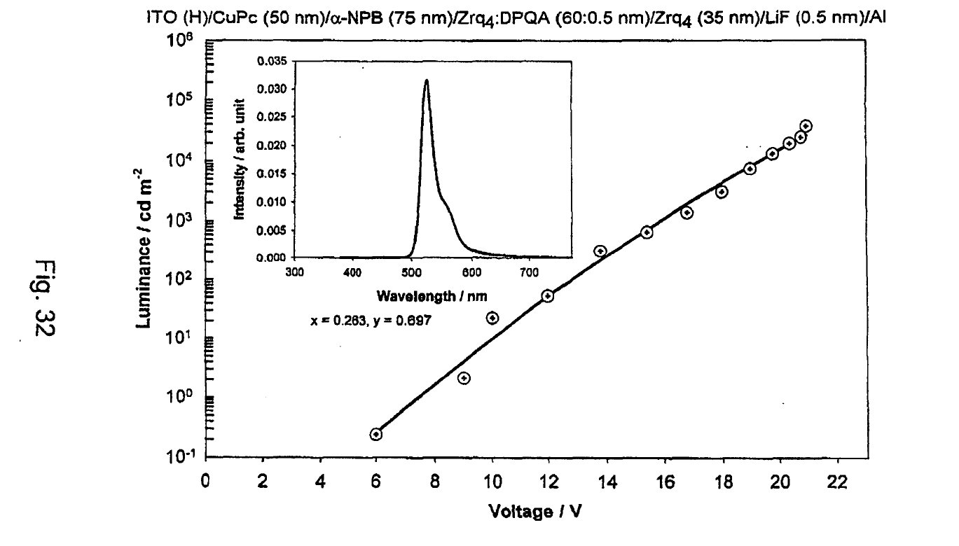

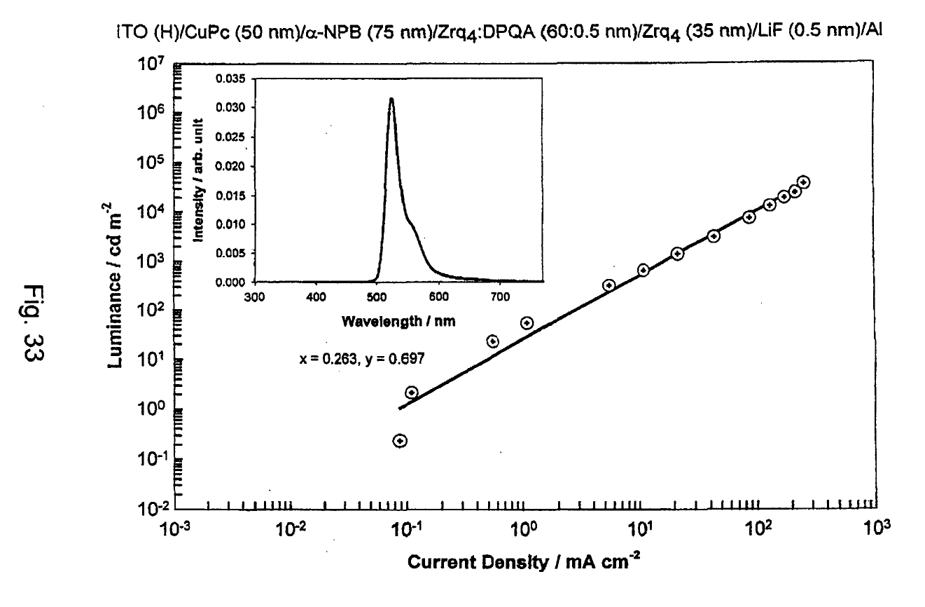

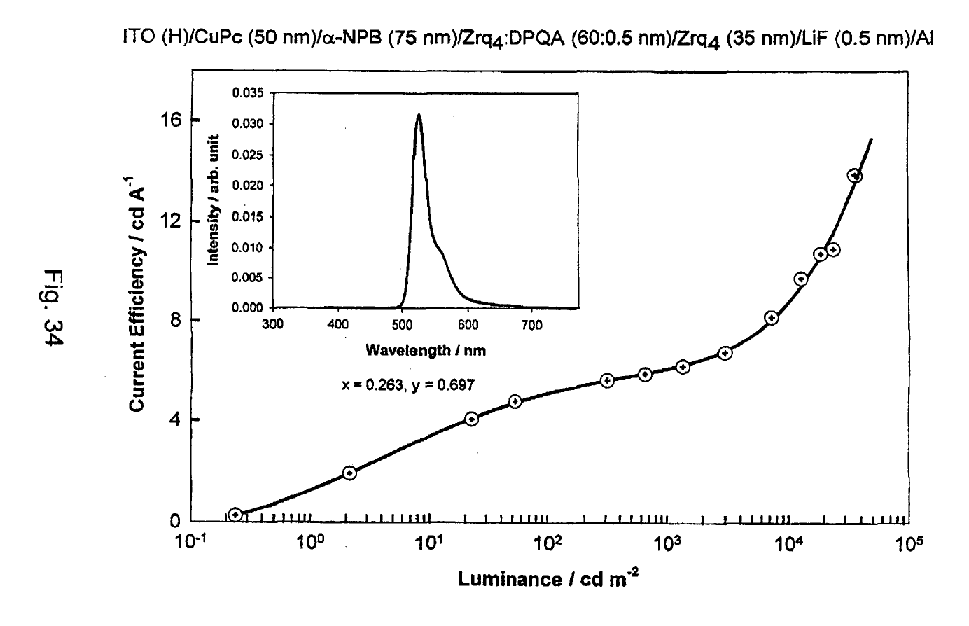

An electric current was applied across the device and the performance shown in FIGS. 32-34.

### EXAMPLE 9

A device was fabricated according to the method of Example 1 with the structure ITO (100 Ω/sqr. m)/CuPc (25 nm)/α-NPB (40 nm)/Zrq₄:DPQA (30:0.2 nm) 1 Zrq₄(10 nm/LiF (0.5 nm)/Al.

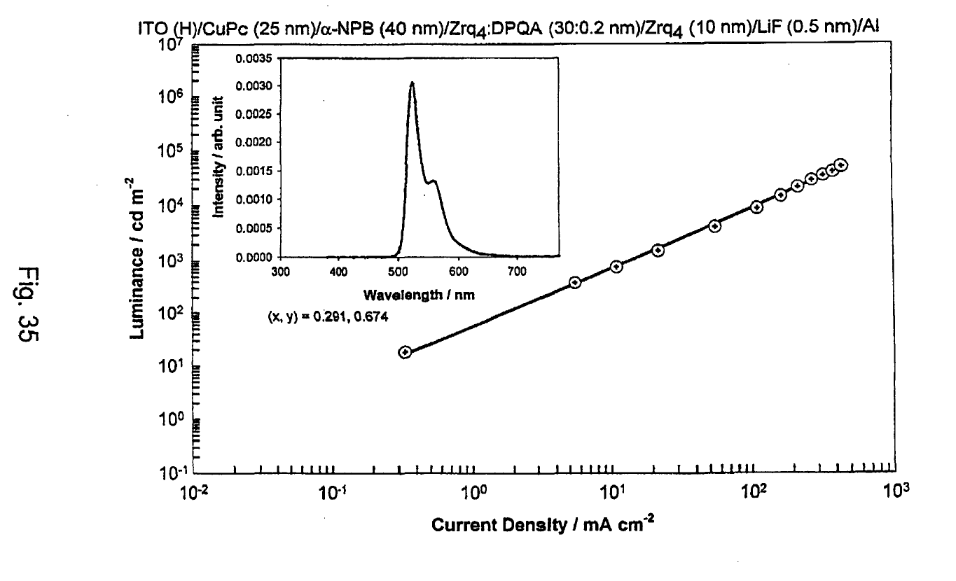

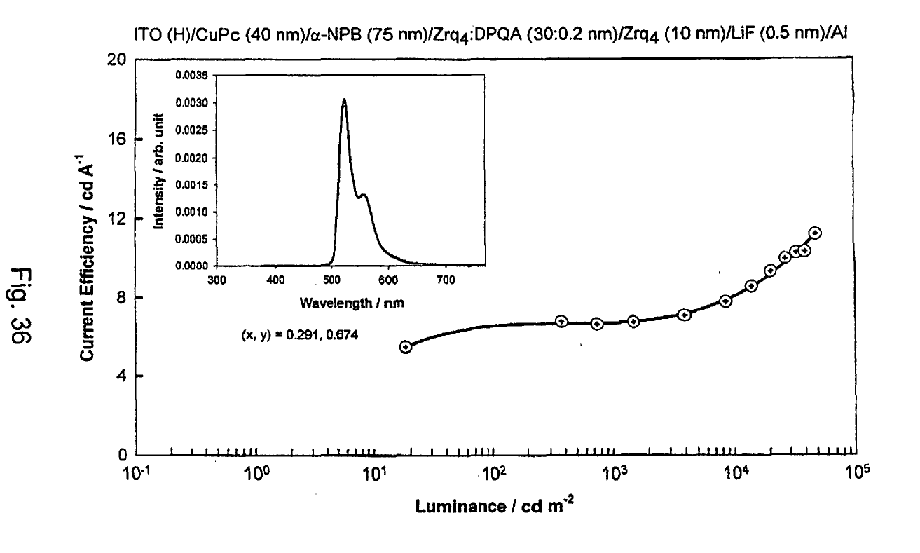

An electric current was applied across the device and the performance shown in FIGS. 35-36.

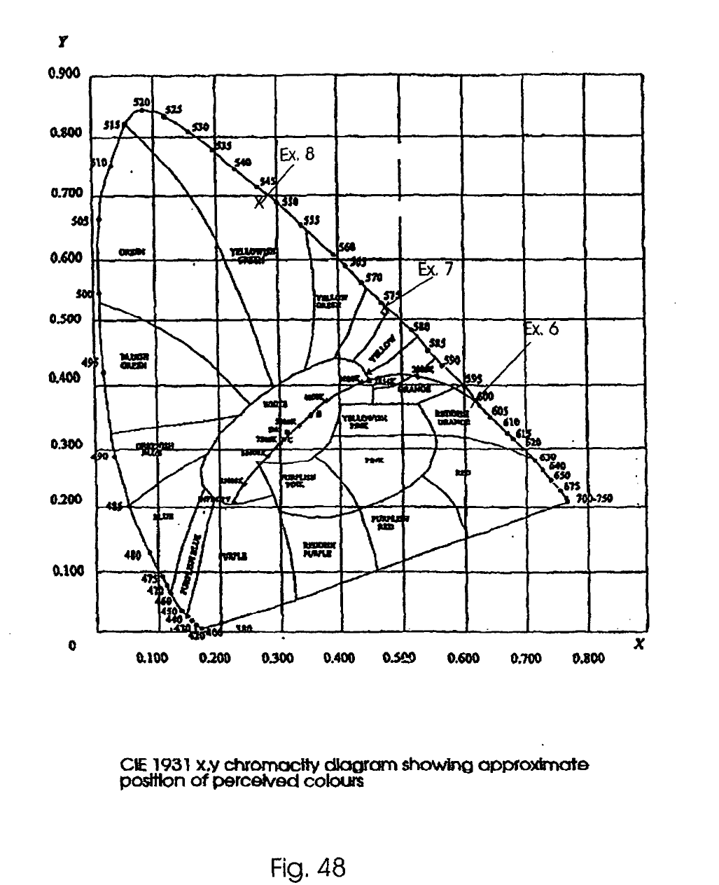

In FIG. 48 are shown the colours of some of the examples on the CIE chart.

### EXAMPLE 10

Comparison of Zirconium and aluminium quinolate (Zrq₄ with Alq₃).

The comparison of zirconium and aluminum quinolates as electroluminescent materials was made under identical conditions.

The devices were fabricated by the same method according to Example 1.

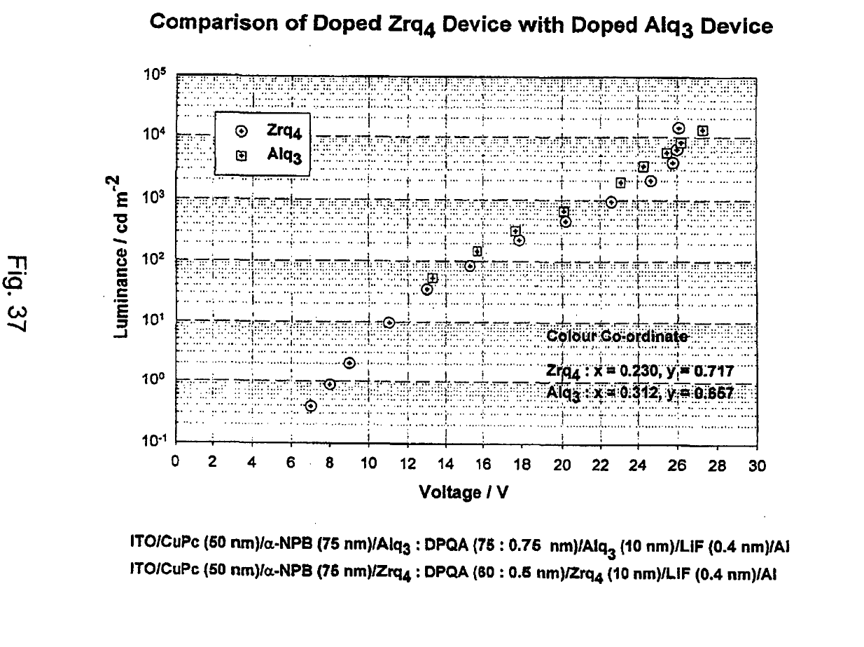

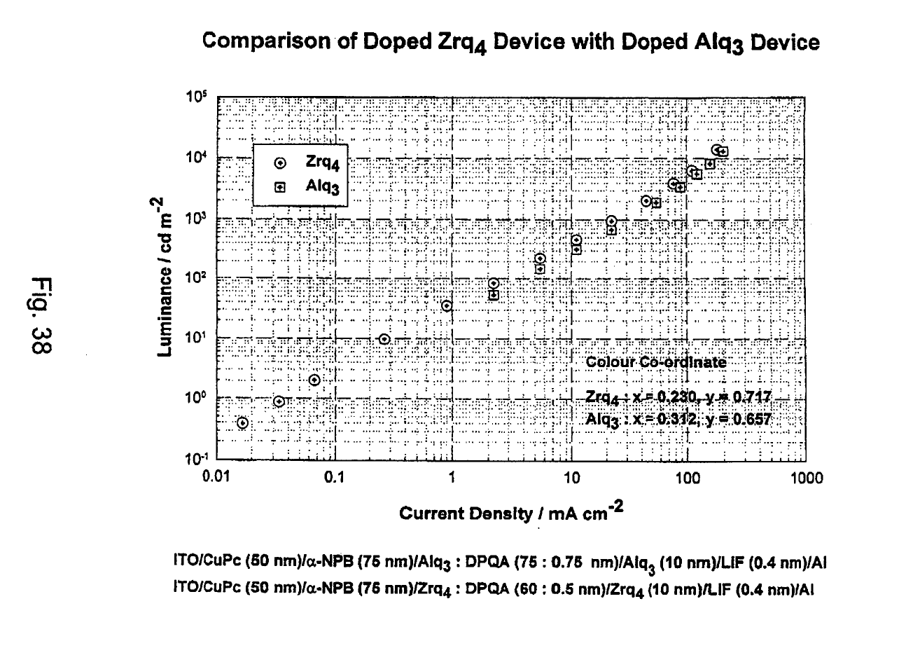

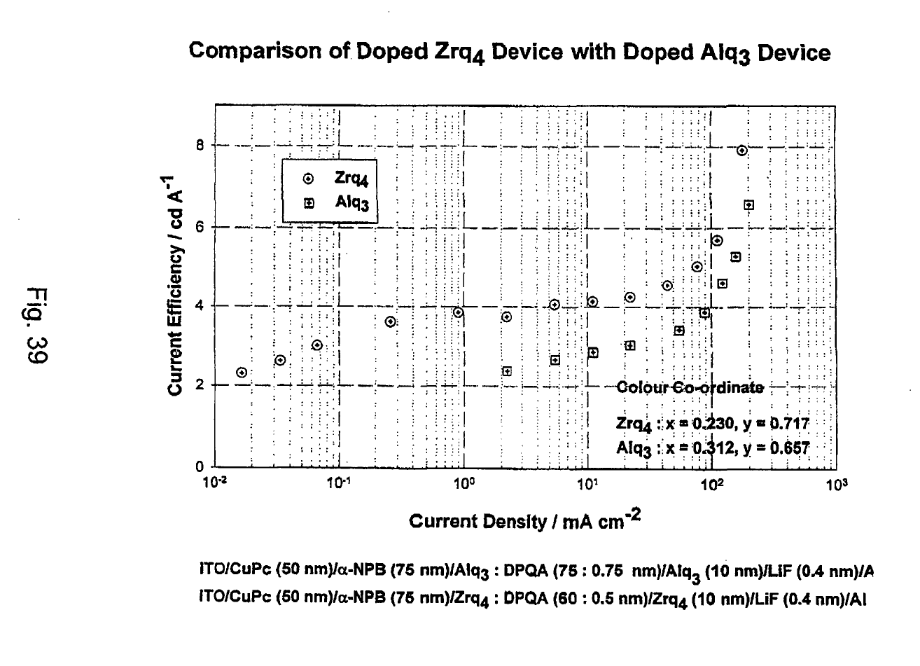

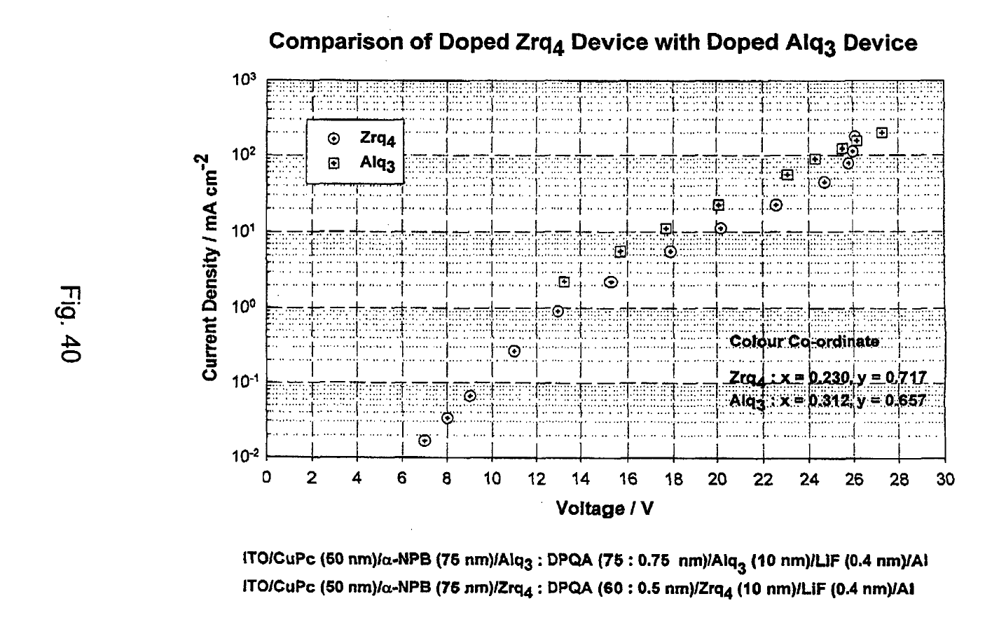

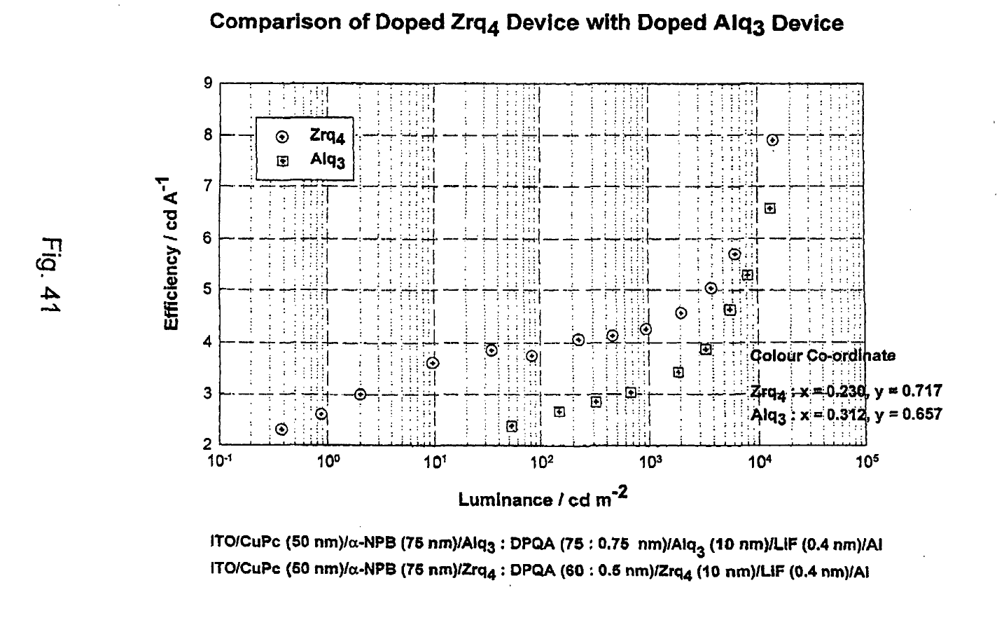

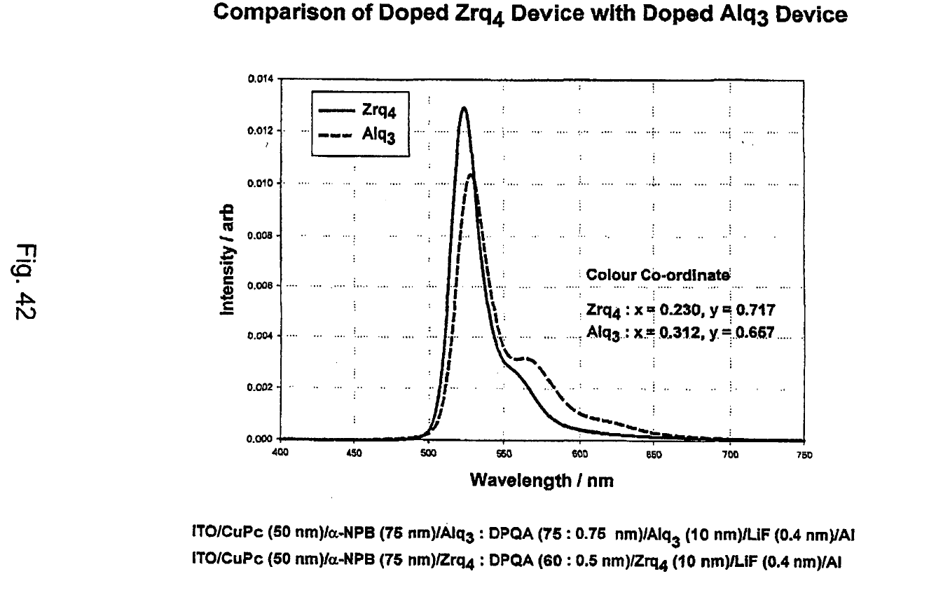

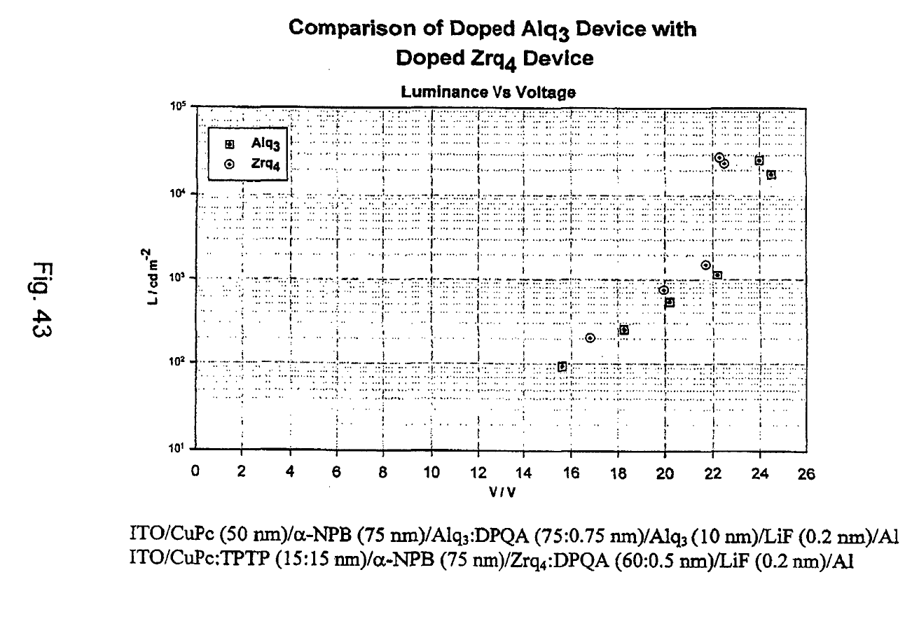

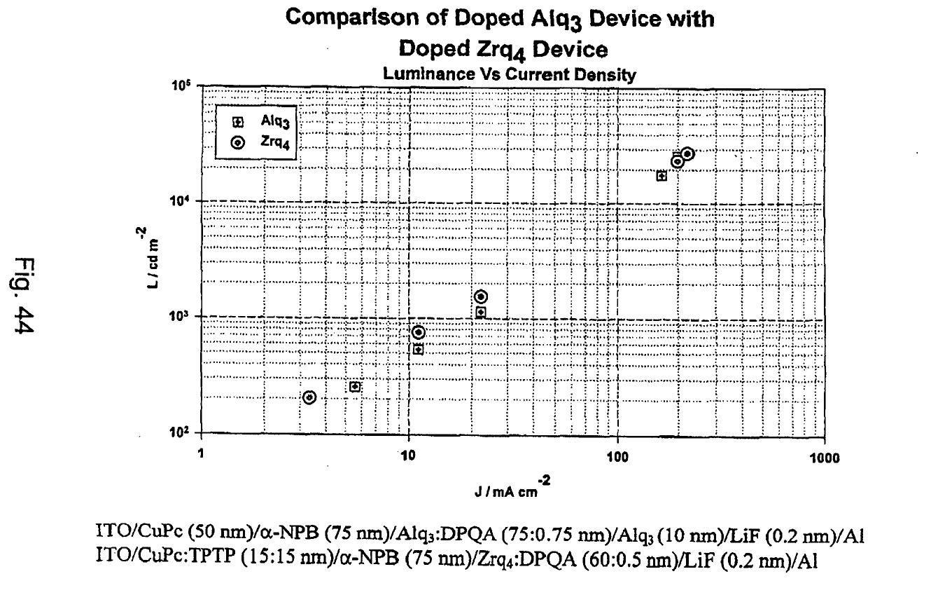

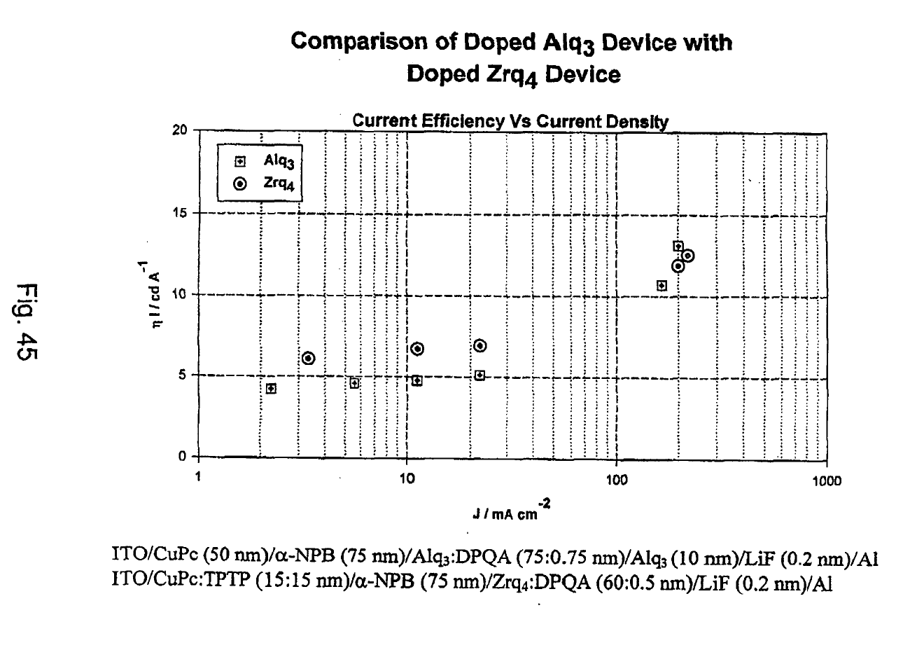

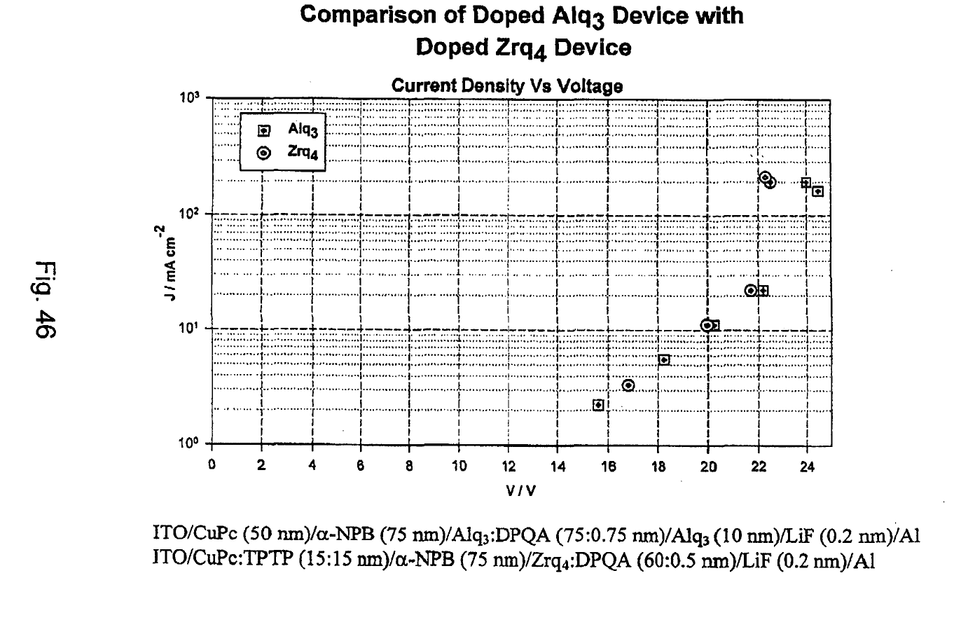

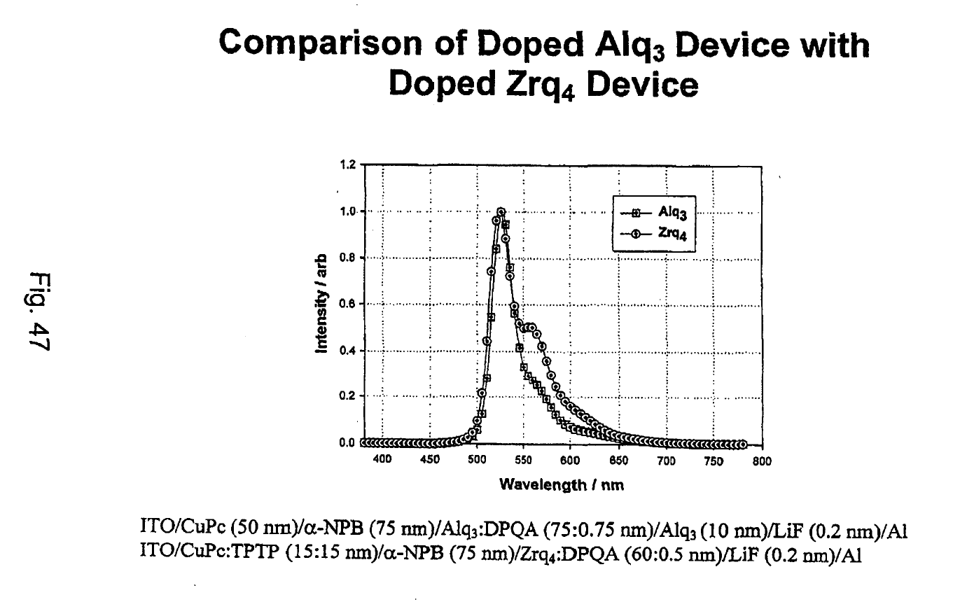

The results are shown graphically in FIGS. 37 to 47 with the electroluminescent devices as in the figures.

The comparison is shown in Table 1

TABLE 1

| Performance | Alq₃ | Zrq₄ |
|---|---|---|
| Efficiency/cd A⁻¹ | 5 | 7 |
| @ 300 cd m⁻² | | |
| Luminance/cd m⁻² | 1100 | 1500 |
| @ 20 mA cm⁻² | | |
| Peak Luminance/cd m⁻² | 2.5 × 10⁴ | 2.8 × 10⁴ |
| Turn on Voltage/V | 7 | 6 |

As can be seen the Zrq₄ had an increase in efficiency of 40% compared with Alq₃ at 300 cd m⁻² and a luminance 36% greater at 20 mA cm⁻².

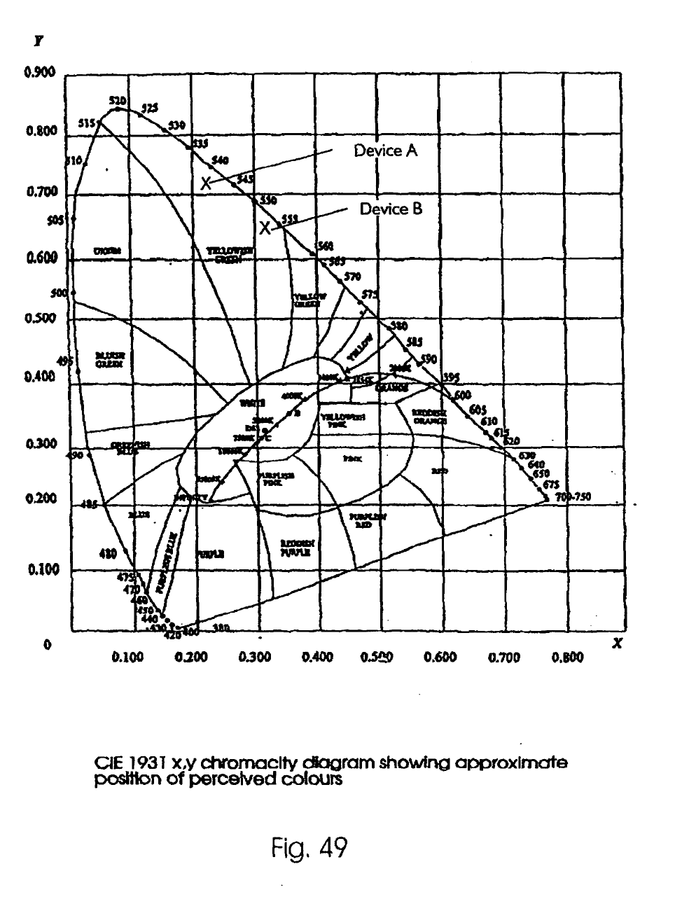

Referring to FIGS. 37 to 47, there is a marked increase in efficiency and improved luminance and lower current density with no reduction or with an improvement in other properties. The colour emitted is improved compared with aluminium quinolate as is shown by the colour coordinates and illustrated in FIG. 49 which shows a CIE color chart with the colour of emissions of devices A and B where devices A and B had the structure of FIGS. 37-42.

1.-36. (canceled)

37. An electroluminescent composition consisting essentially of a mixture of an organometallic compound having the general chemical formula M(L)ₙ or MO(L)ₙ₋₂, where M is a metal in a valency state n of greater than 3, L is an organic ligand wherein the ligands L can be the same or different, and an effective amount of a fluorescent dopant.

38. An electroluminescent composition as claimed in claim 37 wherein the organometallic compound has the general chemical formula 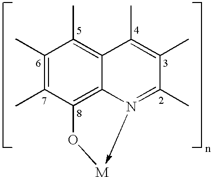
where M is a metal selected from the group consisting of titanium, zirconium or hafnium, each being in the four valency state, or from the group consisting of vanadium, niobium or tantalum, each being in the five valency state; n is the valency state of the metal M, and further wherein the substituents are the same or different in the 2, 3, 4, 5, 6 and 7 positions, said substituents being selected from the group consisting of alkyl, alkoxy, aryl, aryloxy, sulphonic acids, esters, carboxylic acids, amino and amido groups, aromatic, polycyclic and heterocyclic groups.

39. An electroluminescent composition as claimed in claim 37 wherein the dopant is selected from the group consisting of diphenylacridine, coumarins, perylene, quinolates, porphoryin, porphines, pyrazalones and derivatives thereof.

40. An electroluminescent composition as claimed in claim 37 containing up to 10 mole percent of the fluorescent dopant, based on moles of organometallic complex.

41. An electroluminescent device comprising in combination: (i) a first electrode, (ii) a layer of electroluminescent composition, and (iii) a second electrode, wherein the electroluminescent composition is a composition according to claim 37.

42. An electroluminescent device comprising in combination: (i) a first electrode, (ii) a layer of a hole transmitting material, (iii) an electroluminescent layer, (iv) a layer of an electron transmitting material, and (v) a second electrode, wherein the electroluminescent layer comprises a layer of an electroluminescent composition according to claim 37.

43. An electroluminescent device as claimed in claim 42 further wherein the hole transmitting layer is an aromatic amine complex; or is formed from a poly(vinylcarbazole), N,N′-diphenyl-N,N′-bis (3-methylphenyl)-1,1′-biphenyl-4,4′-diamine (TPD), polyaniline, or a substituted polyaniline; or has a general chemical formula (II) or (III) below: 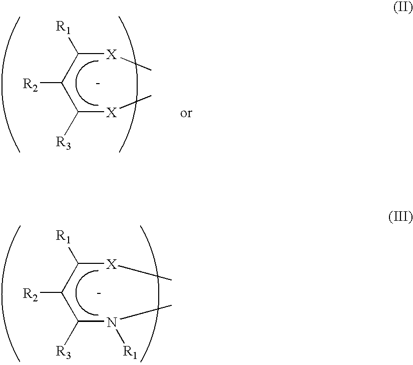
where R₁, R₂ and R₃ are the same or different and are selected from hydrogen, and substituted and unsubstituted hydrocarbyl groups, substituted and unsubstituted aromatic, heterocyclic and polycyclic ring structures, fluorocarbons, halogens, and thiophenyl groups; R₁, R₂ and R₃ also may be selected from substituted and unsubstituted fused aromatic, heterocyclic and polycyclic ring structures and can be copolymerisable with a monomer; X is selected from Se, S or O; and Y is selected from hydrogen, substituted and unsubstituted hydrocarbyl groups, fluorine, fluorocarbons, halogens, thiophenyl groups, and nitrile groups;
or has a general chemical formula selected from FIGS. 1A-1D and the following: 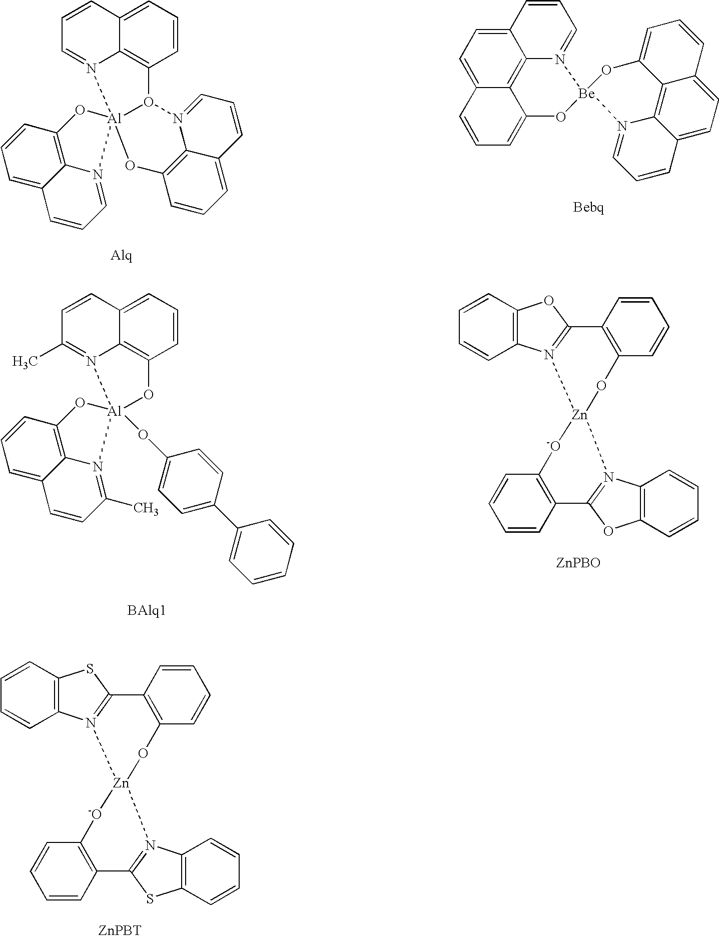 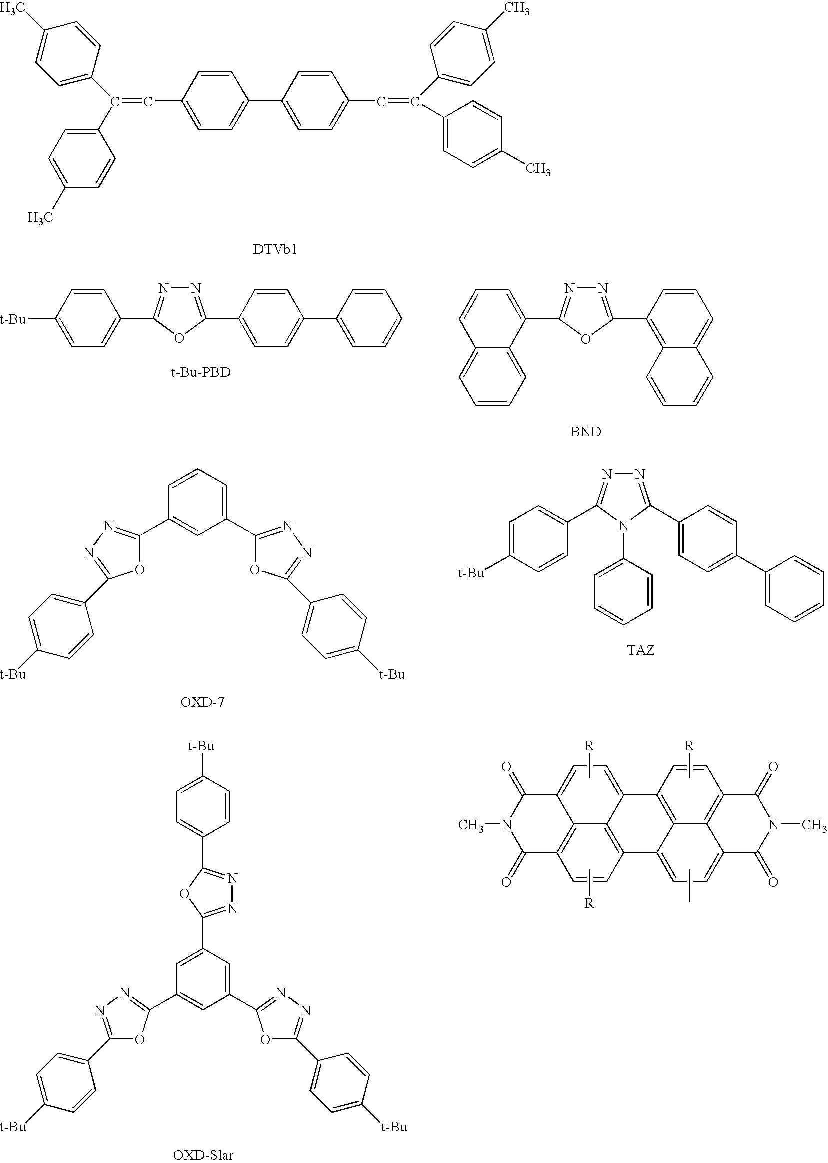 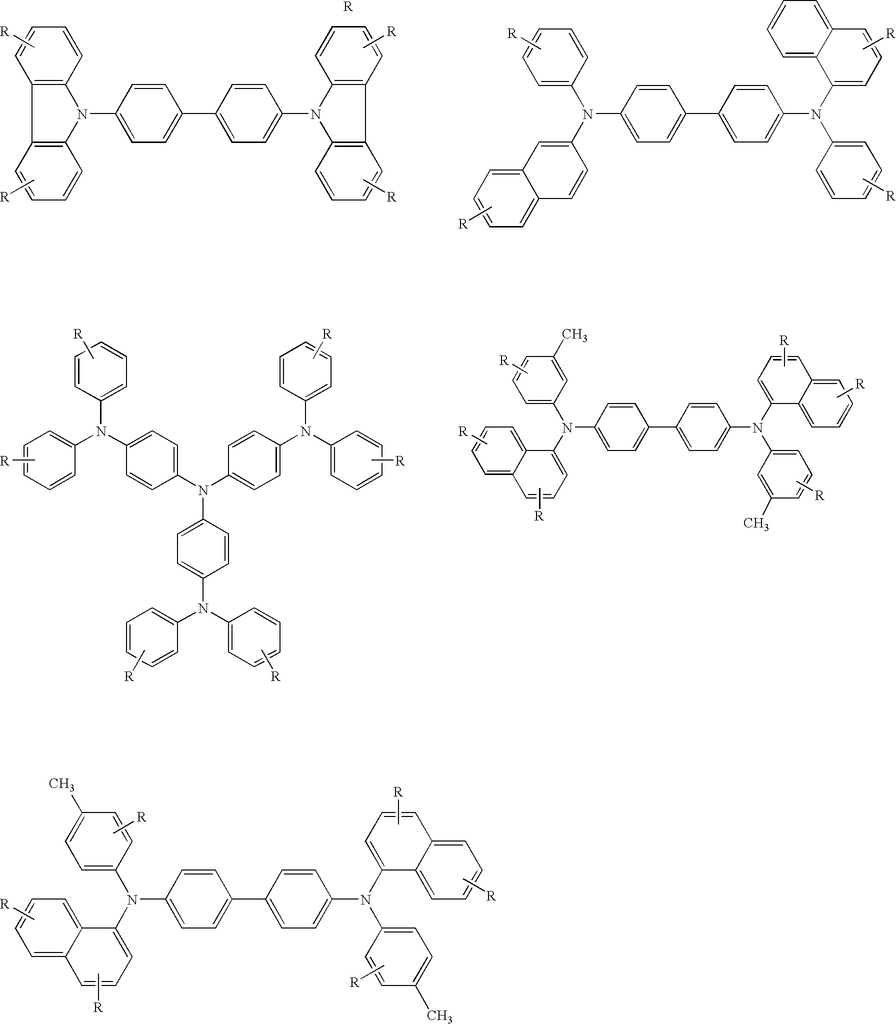 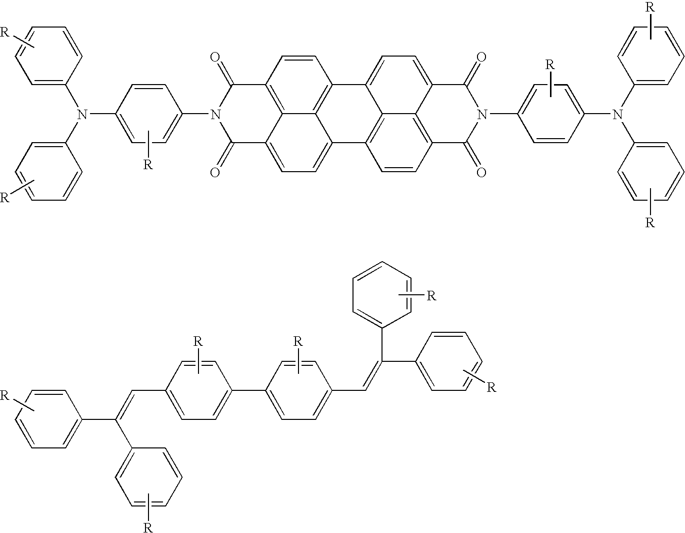
or is selected from poly (p-phenylenevinylene)-PPV and copolymers including PPV, poly(2,5 dialkoxyphenylene vinylene), poly (2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, polythiophenes and oligothiophenes.

44. An electroluminescent device as claimed in claim 42 further wherein the electron transmitting material is selected from a metal quinolate, aluminium or scandium dibenzoyl membrane, or has a general chemical formula selected from FIGS. 14a and 14b and the following: 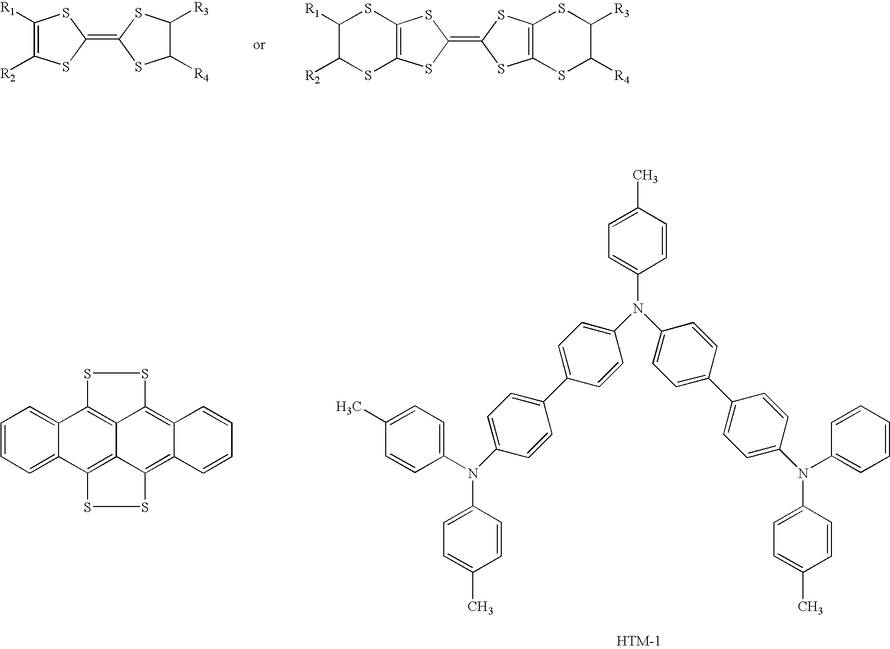 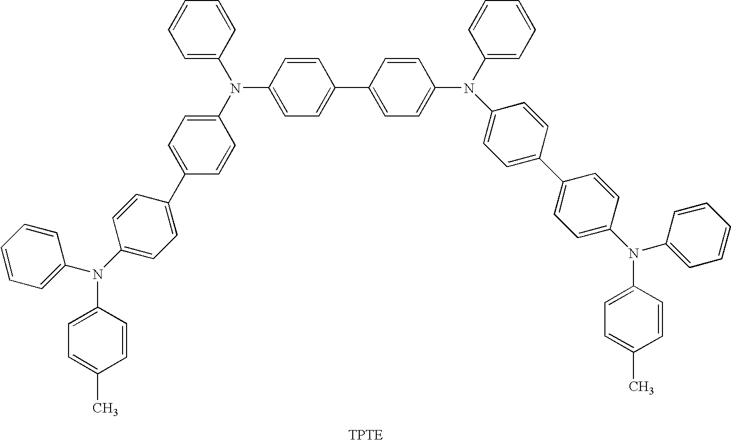
or is selected from lithium, sodium, potassium, zinc, magnesium or aluminium quinolate.

45. An electroluminescent device as claimed in claim 42 further wherein the hole transmitting material and the electroluminescent compound are mixed to form one layer in a proportion of the two materials ranging from about 5 to 95% of the hole transmitting material to 95 to 5% of the electroluminescent compound, or wherein the electron transmitting material and the electroluminescent compound are mixed to form one layer in a proportion of the two materials ranging from about 5 to 95% of the electron transmitting material to 95 to 5% of the electroluminescent compound.

46. An electroluminescent device as claimed in claim 42 further wherein there is a copper phthalocyanine layer on the first electrode and a metal fluoride layer on the second electrode.

47. An electroluminescent device as claimed in claim 41 wherein there is a layer of a hole transmitting material positioned between the first electrode and the electroluminescent layer.

48. An electroluminescent device as claimed in claim 47 wherein the hole transmitting material is an aromatic amine complex.

49. An electroluminescent device as claimed in claim 47 wherein the hole transmitting material is a polyaromatic amine complex.

50. An electroluminescent device as claimed in claim 47 wherein the hole transmitting material is a film of a polymer selected from poly(vinylcarbazole), N,N′-diphenyl-N,N′-bis (3-methylphenyl)-1,1′-biphenyl 4,4′-diamine (TPD), polyaniline, substituted polyanilines, polythiophenes, substituted polythiophenes, polysilanes and substituted polysilanes.

51. An electroluminescent device as claimed in claim 47 wherein the hole transmitting material is a film of a compound having the general chemical formula (XIX) or (XX) below: 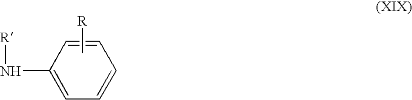
where R is in the ortho- or meta-position and is selected from hydrogen, C1-18 alkyl groups, C1-6 alkoxy groups, amino groups, chloro groups, bromo groups, hydroxy groups and the group 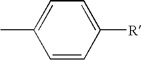
where R is alkyl or aryl and R′ is selected from hydrogen, C1-6 alkyl groups or aryl groups with at least one other monomer having the general chemical formula I below: 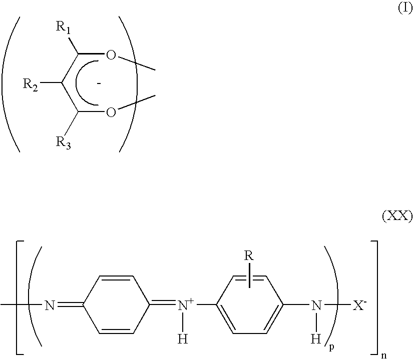
where p is an integer from 1 to 10, n is an integer from 1 to 20, R is as defined above and X is an anion, selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, viylbenzene sulphonate, cellulose sulphonate, camphor sulphonates, cellulose sulphate and a perfluorinated polyanion;
or has a general chemical formula selected from FIGS. 14a and 14b and the following:

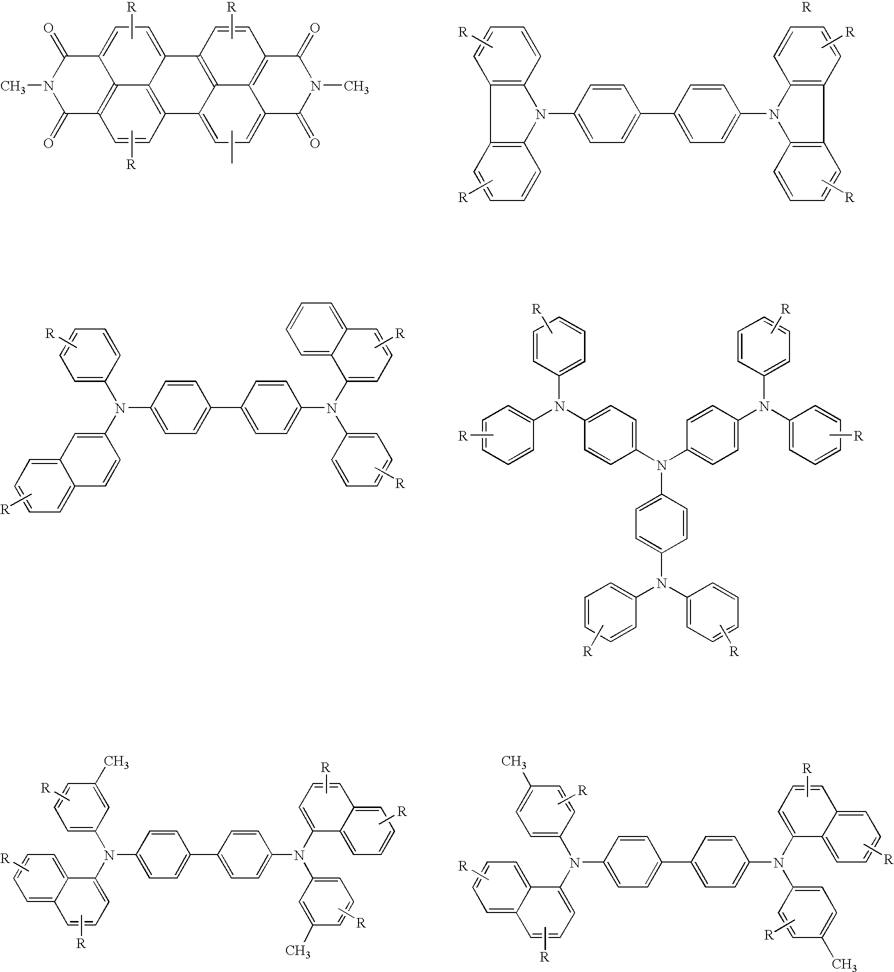

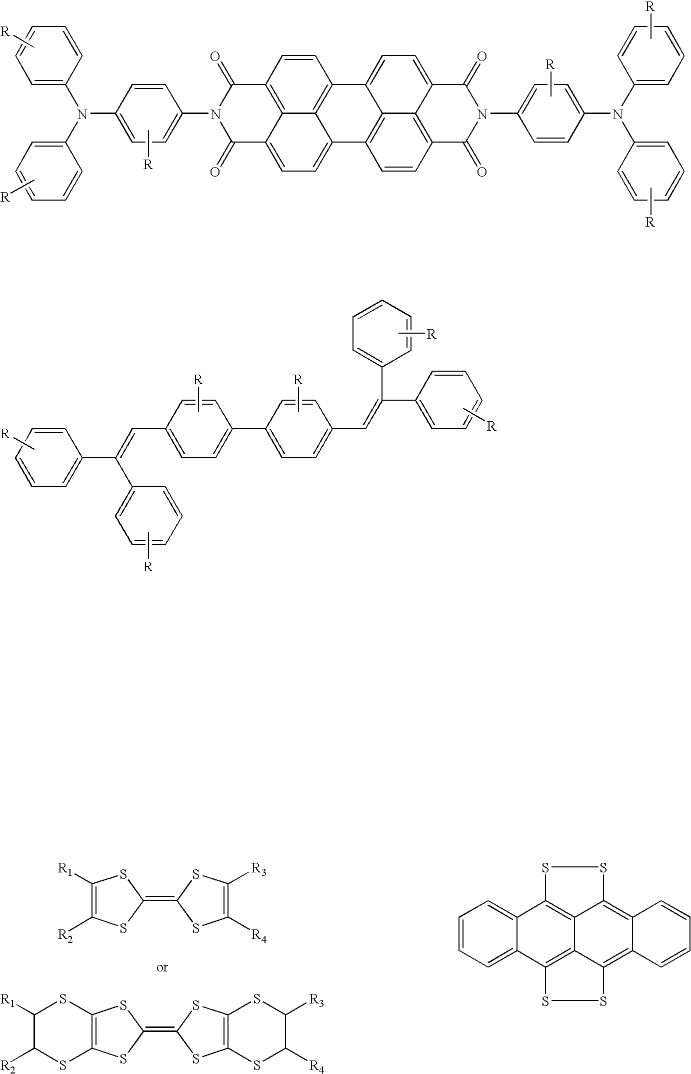

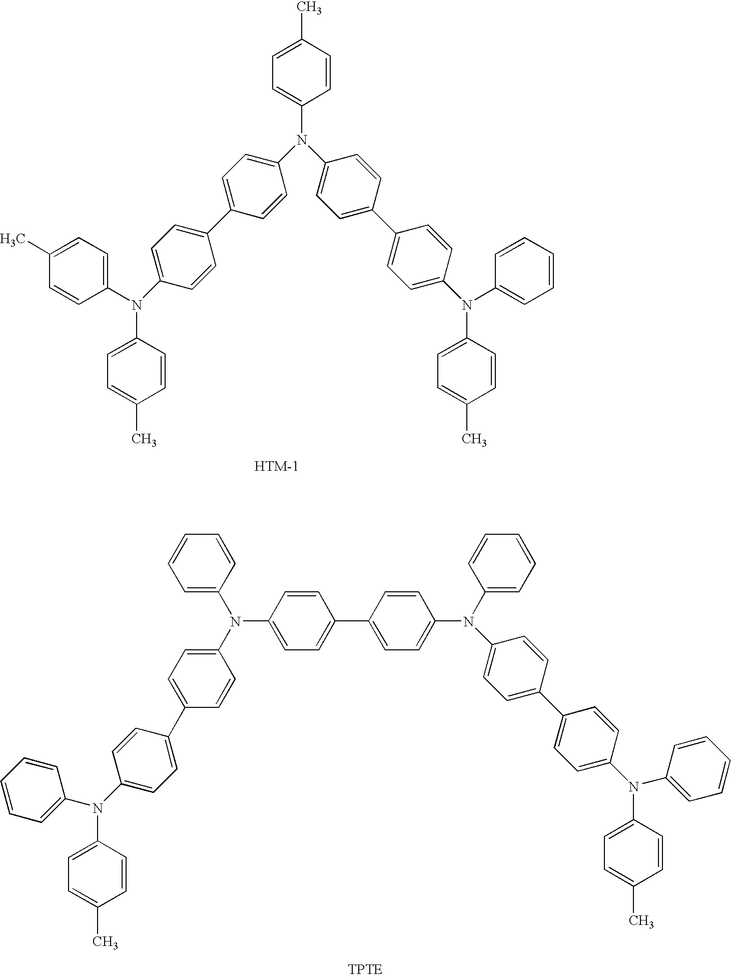

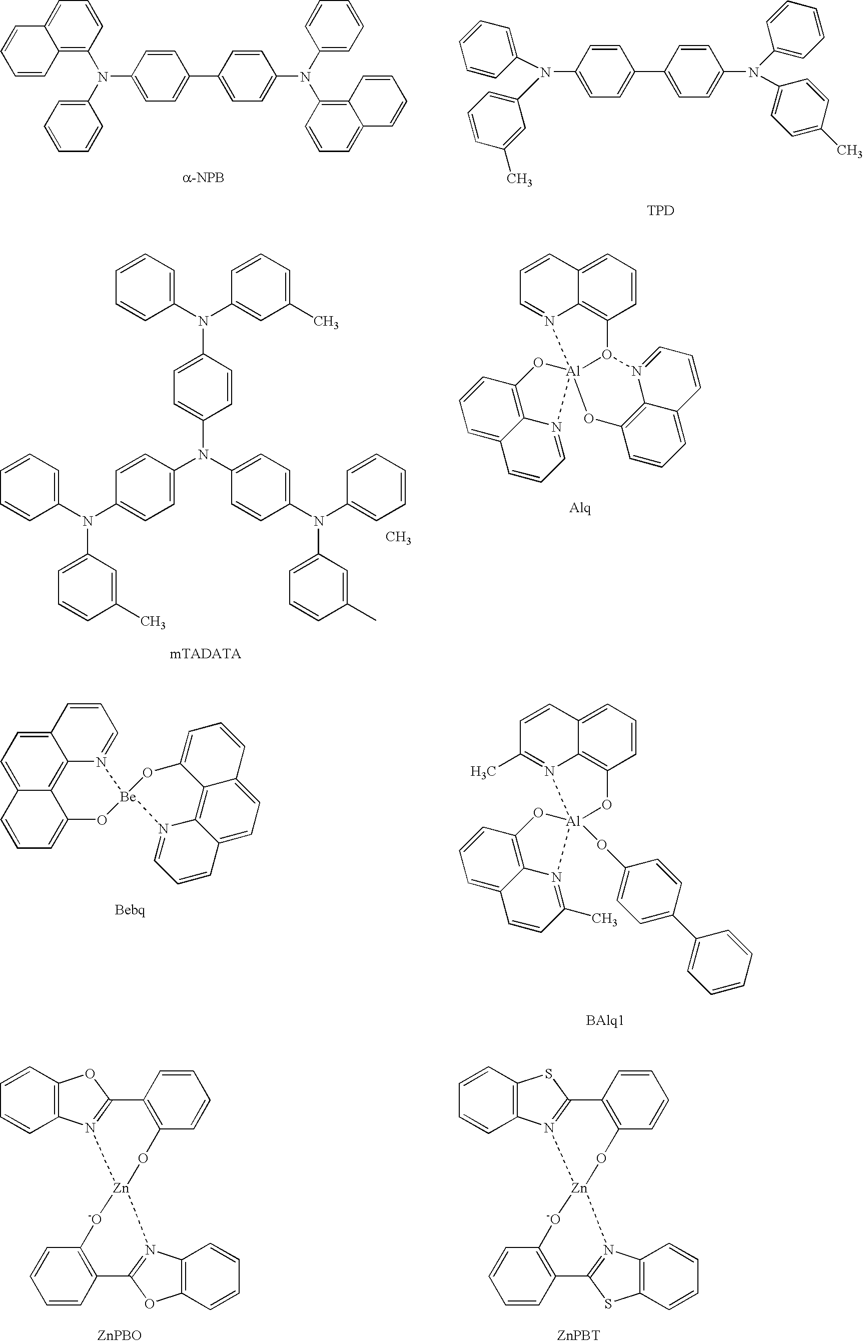

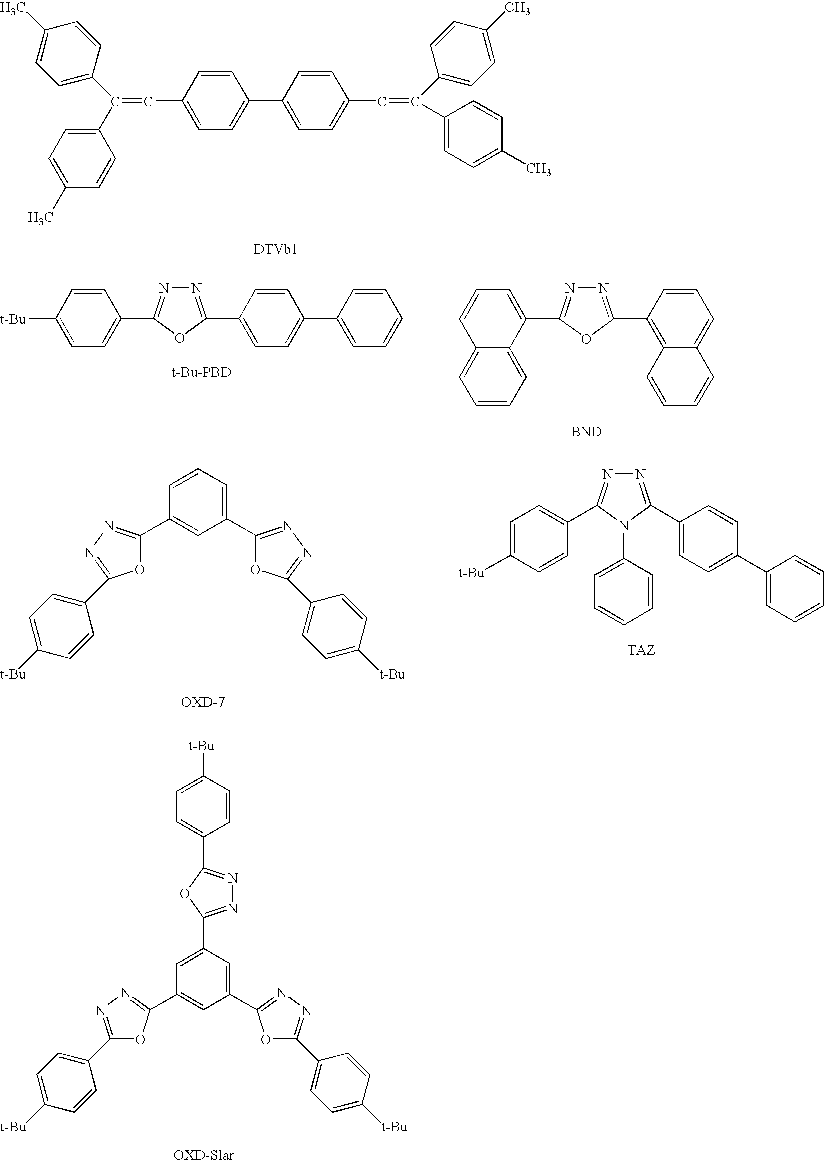

52. An electroluminescent device as claimed in claim 47 wherein the hole transmitting material is selected from a copolymer of aniline, a copolymer of aniline with o-anisidine, m-sulphanilic acid or o-aminophenol, or o-toluidine with o-aminophenol, o-ethylaniline, o-phenylene diamine or with an amino anthracene.

53. An electroluminescent device as claimed in claim 47 wherein the hole transmitting material is a conjugated polymer.

54. An electroluminescent device as claimed in claim 53 wherein the conjugated polymer is selected from poly (p-phenylenevinylene)-PPV and copolymers of PPV, poly(2,5 dialkoxyphenylene vinylene), poly (2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes), further wherein at least one alkoxy group of said polymers is a long chain solubilising alkoxy group; poly fluorenes and oligofluorenes; polyphenylenes and oligophenylenes; polyanthracenes and oligo anthracenes; and polythiophenes and oligothiophenes.

55. An electroluminescent device as claimed in claim 47 wherein the electroluminescent compound is mixed with an effective amount of the hole transmitting material.

56. An electroluminescent device as claimed in claim 47 wherein one of said electrodes is a cathode and further wherein there is a layer of an electron transmitting material between the cathode and the electroluminescent compound layer.

57. An electroluminescent device as claimed in claim 56 wherein the electron transmitting material is a metal quinolate.

58. An electroluminescent device as claimed in claim 57 wherein the metal quinolate is selected from aluminium quinolate, zirconium quinolate, and lithium quinolate.

59. An electroluminescent device as claimed in claim 57 wherein the electron transmitting material has the general chemical formula Mx(DBM)ₙ, where Mx is a metal, DBM is dibenzoyl methane, and n is the valency of Mx.

60. An electroluminescent device as claimed in claim 56 wherein the electron transmitting material is a cyano anthracene, a polystyrene sulphonate, or a compound having a general chemical formula selected from one of the following:

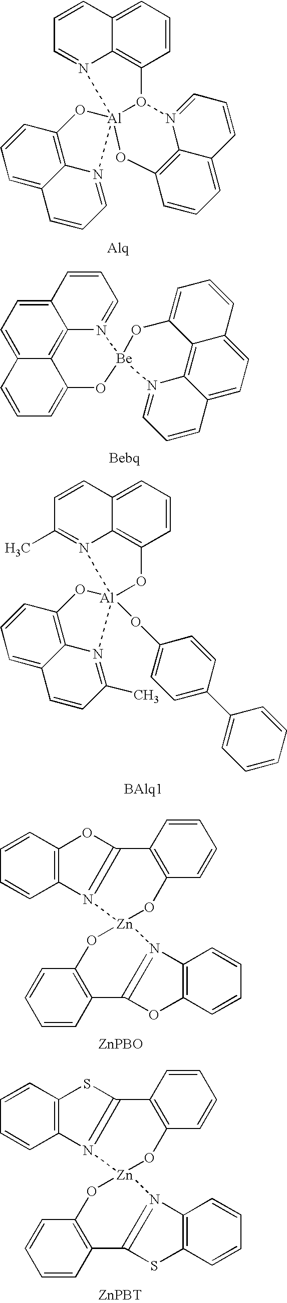

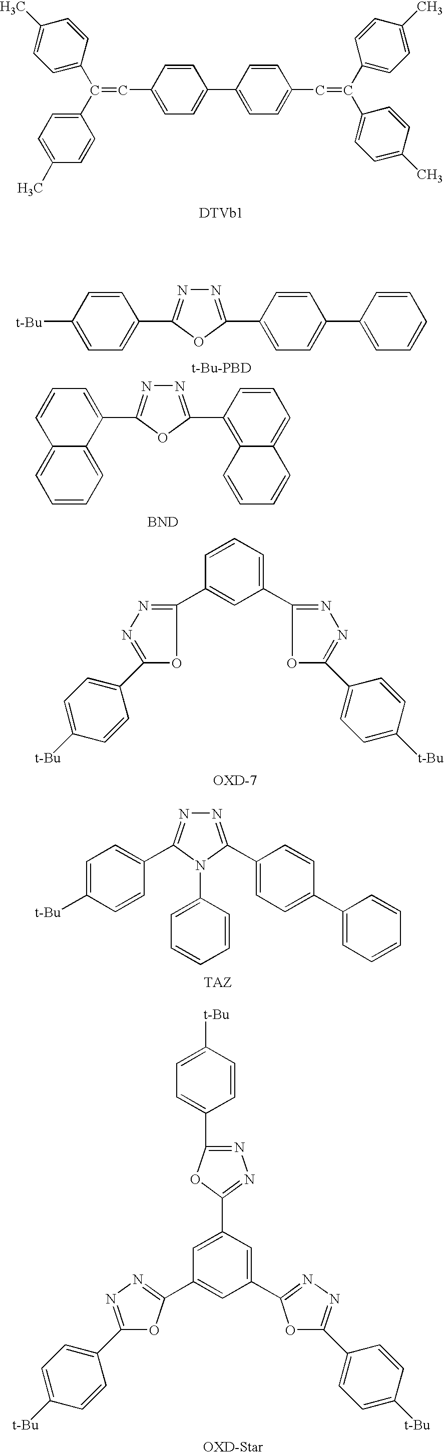

61. An electroluminescent device as claimed in claim 56 wherein the electron transmitting material is mixed with an effective amount of the electroluminescent compound.

62. An electroluminescent device as claimed in claim 47 wherein the first electrode is a transparent electricity conducting glass electrode.

63. An electroluminescent device as claimed in claim 47 wherein the second electrode is selected from aluminium, calcium, lithium, magnesium and alloys thereof, and silver/magnesium alloys.
